(19) United States
(12) Patent Application Publication
(10) Pub. No.: US 2010/0049536 A1
(43) Pub. Date: Feb. 25, 2010

(54) METHODS FOR CREATING CONSOLIDATED MAILPIECES

(75) Inventors: Douglas B. Quine, Bethel, CT (US); Bradley R. Hammell, Southbury, CT (US); Frederick W. Ryan, JR., Oxford, CT (US); Matthew J. Campagna, Ridgefield, CT (US); Erik D.N. Monsen, Arlington, VA (US); Michael P. Swenson, Danbury, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/195,729

(22) Filed: Aug. 21, 2008

(51) Int. Cl. G06Q 99/00; B65D 27/06

(52) U.S. Cl. 705/1; 229/301

(57) ABSTRACT

A method includes receiving a plurality of mail messages. The plurality of mail messages are all appointed for delivery by mail to the same recipient. Each of the mail messages includes a respective account number for the mail recipient. The method further includes combining the received mail messages into a single combined mailpiece addressed to the mail recipient. All of the account numbers included in the mail messages are mutually different from each other.

### FIELD OF THE INVENTION

The invention disclosed herein relates generally to generation and/or processing of large mailings prior to delivery of the same to a postal authority.

### BACKGROUND

Over the last few decades, the United States Postal Service (USPS) has offered postal rate discounts with respect to large mailings that are arranged in a manner that reduces the amount of work required on the part of the USPS to sort the mailings. For example, mail that is sorted by 3- or 5-digit ZIP code prior to induction into the USPS receives a substantial discount, assuming that it meets minimum quantity requirements. Discounts of this kind are designed to give mailers incentives for “worksharing” with the USPS.

For mailers with sufficient mail volume, it is a common practice to generate (i.e., to print) a mailing on a ZIP code by ZIP code basis, so that in effect the mailing does not require ZIP code sorting. This is done, for example, by arranging the print file for the mailing by ZIP code. For other mailers, it is a common practice to deliver their mail to a so-called “pre-sort house” which combines the mailings of two or more different mailers to achieve necessary mail volumes and sorts the mail by 3- or 5-digit ZIP code to qualify for the above-mentioned discounts. Typically the sorting is done automatically by machine by reading barcodes (e.g., POSTNET or “intelligent mail” barcode (IMB)) that indicate the intended delivery point for the mailpieces (e.g. 11-digit ZIP codes). The pre-sort house shares the postal discount with the mailers.

Pitney Bowes PSI, a subsidiary of the assignee hereof, is a leading pre-sort house.

The present inventors have recognized that there are opportunities to generate or pre-sort mailings in innovative ways that in effect achieve greater discounts on postage than those that have heretofore been realized via worksharing. The practices disclosed herein go beyond such conventional practices as consolidated billing of local and long distance telephone service, or shared advertising mail packets (e.g., those commonly distributed by ADVO), or the proposed USPS practice (called “Delivery Point Packaging”) of rubber banding together, at the destination post office, mailpieces that are to be delivered to a common address.

### SUMMARY

According to an aspect of the invention, a method includes receiving a plurality of mail messages from different mailers. The method further includes sorting together ones of the mail messages that are all appointed for delivery by mail to the same mail recipient. Each of the mail messages includes a respective account number for the mail recipient. The method further includes combining the mail messages that have been sorted together into a single combined mailpiece addressed to the mail recipient. All of the account numbers included in the mail messages are mutually different from each other.

As used herein and in the appended claims, the term “mail message” refers to information that is either in electronic form or embodied in tangible physical form, addressed to a recipient, and intended to be delivered by mail to the recipient. As used herein and in the appended claims, “mail” refers to a delivery service for letters and/or parcels provided by a postal authority or by a private carrier such as FedEx or UPS.

The mail messages may include one or more of: (a) a telecommunications bill; (b) a payment card account bill (e.g., a credit card bill); (c) a utility bill; and (d) a periodic mortgage account statement.

Each of the mail messages may be received in association with a recipient identification code (RID) that corresponds to the mail recipient. The RID may be different from the mail recipient's account numbers. The RID may be a number or alphanumeric code that uniquely identifies the mail recipient for purposes of mail message consolidation. The RID may be associated with the mail recipient's destination, as identified by a destination identification code (DID) such as an 11-digit ZIP code.

The single combined mailpiece may be for notifying the mail recipient of at least two account statements for which the mail recipient owes payment. For example, the plurality of mail messages may include a first mail message that includes a first account statement issued by a first payment card account issuer and a second mail message that includes a second account statement issued by a second payment card account issuer. The second payment card account issuer is different from the first payment card account issuer. Both the first and second mail messages may be received in electronic form before the combining step.

(As used herein and in the appended claims, the term “payment card account issuer” refers to a financial institution that issues payment cards such as debit and/or credit cards.)

The single combined mailpiece may include a return envelope for allowing the mail recipient to remit at least one payment.

In some alternative embodiments, the mail messages may be received (e.g., at a pre-sort house) in the form of separate mailpieces, which are combined by being sorted together and then physically secured to each other.

According to another aspect of the invention, a consolidated mailpiece includes at least one outer envelope. The consolidated mailpiece further includes a first return envelope and a first remittance slip, both contained in the at least one outer envelope. The remittance slip is appointed for insertion into the first return envelope and is addressed to a first mailer and includes a first account number. The consolidated mailpiece further includes a second return envelope and a second remittance slip, both contained in the at least one outer envelope. The second remittance slip is appointed for insertion into the second return envelope and is addressed to a second mailer and includes a second account number. The second mailer is different from the first mailer and the second account number is different from the first account number.

As used herein and in the appended claims, a “mailer” is an entity that generates mail messages. As used herein and in the appended claims, a remittance slip is a paper document to be inserted with a check into a return envelope for the purpose of aiding a remittee in identifying an account to which the check should be credited. In accordance with conventional practices, the remittance slip may be connected to a sheet of paper via a perforation.

As used herein and in the appended claims, the term “mailpiece” refers to an item that is appointed for induction into a mailpiece carrying organization and that includes an envelope or box with at least one paper sheet contained therein. The term “mailpiece carrying organization” refers to a postal authority or a private entity that delivers letters or parcels. The term “induction” refers to a process that involves receipt of a group of items by a mail carrying organization and collection and/or confirmation of payment of postage.

The at least one outer envelope may include a first outer envelope that contains the first return envelope and the first remittance slip, and a second outer envelope that contains the second return envelope and the second remittance slip. The second outer envelope is secured to the first outer envelope. This may be done via tabs, and by a paper or plastic band, or by having both the first and second outer envelopes contained in an outermost envelope.

According to still another aspect of the invention, a method includes identifying at least one mail message appointed for delivery by mail to each of a plurality of mail recipients. The mail recipients share a mailing address. The method further includes combining the mail messages into a single combined mailpiece addressed to the mailing address, and dispatching the single combined mailpiece for induction into a mailpiece carrying organization.

The mail messages may each be separate mailpieces that are addressed to one of the recipients. The mail messages may be sorted together in a pre-sort house and then secured to each other, or may be produced as separate but adjacent mail pieces as part of a mail printing and generating operation, and then secured to each other. Alternatively, the mail messages may be combined into a print file printed on one or more paper sheets that are subsequently inserted into a single envelope.

The combining step may include applying adhesive tabs to the separate mailpieces to physically consolidate the separate mailpieces into the combined mailpiece. Instead of tabbing, the combining step may alternatively include applying a paper or plastic band to the separate mailpieces to physically consolidate the separate mailpieces into the single combined mailpiece, or enclosing the separate mailpieces in a common envelope.

The identifying step may include applying delivery point pre-sorting to the separate mailpieces. The identifying step need not include reading the recipient's names, but may be sufficiently accomplished by reading a DID (destination identification code).

The method according to this aspect of the invention may further include paying postage for the single combined mailpiece at a rate that is discounted relative to postage fees that would collectively be incurred for separately mailing the separate mailpieces.

The mail messages may be received in electronic form, and the combining step may include combining the mail messages in electronic form into a single print file, and printing the single print file on one or more sheets of paper. The one or more sheets of paper, after printing, may be inserted into a common envelope to assemble the single combined mailpiece.

Each of the messages in electronic form may be associated with a respective RID, and each of the RIDs may correspond to a respective one of the mail recipients. All of the RIDs may be associated with a common DID, which corresponds to the shared mailing address. The DID may be a 9- or 11-digit ZIP code.

According to yet another aspect of the invention, a method includes receiving a plurality of mail messages. Each of the mail messages originates from a respective one of a plurality of entities. No two of the mail messages originates from the same entity. All of the mail messages are appointed for delivery to the same mail recipient. The plurality of entities includes at least two of the following types of entities: (a) a payment card issuer; (b) an energy utility; (c) a telecommunications carrier; (d) a mortgage servicing entity; (e) a taxing authority; (f) a securities brokerage company; (g) an insurance company; and (h) a government agency. The method also includes combining the received mailpieces into a single combined mailpiece addressed to the mail recipient.

Each of the mail messages may include a monthly account statement issued for the mail recipient by the respective one of the plurality of entities. Each of the mail messages may include a respective account number for the mail recipient, with no two of the account numbers being the same.

The mail messages may be received in electronic form. Each may be associated with an RID that corresponds to the mail recipient. The RID may be associated with a DID. The DID may be a 9- or 11-digit ZIP code.

The method may further include dispatching the single combined mailpiece for induction into a mailpiece carrying organization (e.g., the USPS).

The method may further include paying postage for the single combined mailpiece at a rate that is discounted relative to postage fees that would collectively be incurred for separately mailing the separate mail messages.

In another aspect of the invention, a method includes receiving plural batches of mail and combining the batches of mailpieces to produce a combined batch. The method further includes sorting at least a portion of the combined batch by delivery point, to generate a plurality of groups of mailpieces, where each group is destined for a respective delivery point. The method further includes securing together each of the groups of mailpieces to produce a plurality of combined mailpieces.

The securing step may include tabbing or banding together each of the groups of mailpieces, or inserting each of the groups of mailpieces into a respective outermost envelope. The sorting and securing steps may be performed automatically by machine.

The method according to this aspect of the invention may further include inducting the combined batch including the combined mailpieces into a mailpiece carrying organization such as the USPS.

According to yet another aspect of the invention, a method includes generating a mailing in a printing facility. The method further includes outsorting, from the mailing, groups of mailpieces. Each group of mailpieces includes at least two of the mailpieces. All of the respective mailpieces in each group are addressed to the same delivery address. The method further includes securing each group of mailpieces together to form a combined mailpiece from the respective group of mailpieces. Each of the combined mailpieces has a top envelope.

The outsorting may occur without reading address information from the mailpieces. The method may further include, for each combined mailpiece, applying postage only to the top envelope of the combined mailpiece.

According to still another aspect of the invention, a method includes providing a system for receiving information that represents mail recipients' preferences regarding letter mail to be sent to the mail recipients, and generating letter mail addressed to the recipients in accordance with the received information. The mail recipients' preferences may include at least one of the following: (a) an order in which mail messages are to be positioned in the letter mail; (b) whether coupons are to be included in the letter mail; (c) what types of coupons are to be included in the letter mail; (d) whether mail messages for more than one recipient are to be combined in a single mailpiece; (e) whether mail messages for more than one recipient are to be inserted together into an envelope; (f) whether a return envelope or return envelopes are to be inserted in letter mail sent to the recipients; (g) selection of a format in which mail messages are to be printed prior to insertion into an envelope; (h) selection of an order in which mail messages are to be printed prior to insertion into an envelope; (i) whether a mailing service bureau is authorized to maintain records concerning letter mail sent from the mailing service bureau to the recipients; (j) whether the recipients prefer that the mailing service bureau maintain records concerning letter mail sent from the mailing service bureau to the recipients; and (k) whether a consolidated remittance slip is to be included in mailpieces sent to recipients.

The system may host a website that is accessible by mail recipients for entering their preferences, and/or may include an automated voice response system.

One or more of these aspects of the invention may provide significant savings in postage and/or other costs relating to large mailings. One or more aspects may also provide greater convenience for mail recipients.

For example, where large combined batches of mail are pre-sorted to the delivery point, and then mailpieces sharing the same destination are consolidated together, by tabbing or the like, the resulting consolidated mailpieces may be mailed for an amount of postage that is significantly below that which would be paid if the mailpieces were not consolidated and were mailed as separate items. For example, even if two one-ounce mailpieces were consolidated to form a two-ounce consolidated mailpiece, the postage due for the consolidated mailpiece would be very much less than the postage for two one-ounce mailpieces. That is because the postage rates (at least in the U.S.) greatly discount the second and additional ounces for a mailpiece relative to the postage rate for the first ounce. This reflects the relatively large cost to the postal authority of separately sorting and handling separate mailpieces.

Even greater savings may be available where the weight of the consolidated mailpiece does not exceed one ounce (i.e., where the total weight of the constituent mailpieces combined into the consolidated mailpiece is not more than one ounce). In such cases, the additional mailpiece or mailpieces essentially are mailed free of postage, or one could say that the one-ounce postage rate is split among the two or three (or possibly more) mailpieces combined into the consolidated mailpieces. These postage savings may be shared between a pre-sort house that performs the delivery point sortation and mailpiece consolidation and the mailers whose mail is consolidated by the pre-sort house. The savings may reflect overall increased efficiencies in mail handling and improved worksharing. Moreover, savings of this kind would not require any modification of current postal rate structures.

As an alternative to physical consolidation of mailpieces at a pre-sort house, similar postage savings may be realized by electronic consolidation of batches of mail messages in electronic form into a consolidated mailing print and production run. The electronic consolidation of mail messages may, for example, be performed by a service bureau which receives batches of mail messages from major mailers in electronic form. The service bureau may electronically consolidate the batches of mail messages by electronically sorting together mail messages addressed to the same recipient or address. The service bureau then prints, generates and mails the consolidated batches of mail messages on behalf of the mailers. Such a service bureau may generate savings in printing and production costs in addition to the postage savings.

The service bureau may operate to reflect either or both of mailers' preferences and mail recipients' preferences in generating consolidated mailpieces. With or without a mechanism for collecting and satisfying mail recipients' preferences, the consolidated mailpieces may present the mail messages to the mail recipients in a form that is more organized, manageable and convenient than conventional mail delivery.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system provided according to some aspects of the invention.

FIG. 2 schematically illustrates another aspect of the invention.

FIG. 3 is a block diagram of a computer that may form part of the system of FIG. 1.

FIG. 4 is a flow chart that illustrates a process that may be performed by or under the control of the computer of FIG. 3.

FIG. 5 is a flow chart that illustrates further details of the process of FIG. 4.

FIG. 6 is a flow chart that illustrates further details of the process of FIG. 5.

FIG. 7 is a schematic illustration of a consolidated mailpiece that may be produced in the system of FIG. 1.

FIG. 8 is a schematic illustration of an alternative embodiment of the consolidated mailpiece of FIG. 7.

FIG. 9 is a block diagram that illustrates a pre-sort house that operates in accordance with aspects of the invention also illustrated in FIG. 2.

FIG. 10 is a block diagram that illustrates a computer that may control at least some operations of the pre-sort house of FIG. 9.

FIG. 11 is a flow chart that illustrates a process that may be at least partially performed or controlled by the computer of FIG. 10.

FIG. 12 is a schematic plan view of an example consolidated mailpiece that may be produced by the pre-sort house of FIG. 9.

FIG. 13 is a schematic illustration of other aspects of the consolidated mailpiece of FIG. 12.

### DETAILED DESCRIPTION

The present invention, in certain of its aspects, is concerned with consolidation of mailpieces for the purpose of saving postage as well as to gain other advantages. The consolidation may be accomplished primarily electronically or primarily by physical sortation, or by a hybrid of the two approaches. In an approach to the invention which primarily employs physical sortation, a pre-sort house may perform additional sortation passes beyond what is needed for 5-digit pre-sort. With sortation to the delivery point (e.g., sortation to the 11-digit ZIP code), mailpieces bound for the same delivery point (e.g., a residence address) may be sorted together, and then secured together to form a consolidated mailpiece formed from two or more mailpieces having the same destination delivery point. The second and any further constituent mailpiece in the consolidated mailpiece may at least partially piggy-back on the postage that would otherwise be paid for the first constituent mailpiece alone.

In an approach to the invention which primarily employs electronic consolidation of mail messages, mailers electronically transmit files of mail messages to a central service bureau. The files of mail messages each include numerous messages, each intended for delivery to a respective mail recipient. For example, a file of mail messages may comprise monthly account statements (possibly but not necessarily monthly bills) for some or all of the customers of the mailer. The service bureau stores the electronic files from two or more mailers. In some embodiments, each mail message in the files includes or is tagged with a recipient identification code (RID) that uniquely identifies the recipient for the purpose of electronic sortation of mail messages. Using the RIDs, the service bureau may associate together for each recipient all of the stored mail messages intended for delivery to the mail recipient.

(In addition, in some embodiments, the mail messages may further be associated with mail messages to other recipients who share the same mailing address.)

The service bureau produces a consolidated electronic file from the files received from the mailers. In the consolidated file, all mail messages to the same mail recipient (or all mail messages for delivery to the same delivery point) are logically adjacent to each other. The service bureau uses the consolidated file to drive a printing and mail production operation so that all mail messages for a single recipient/delivery point are printed on a single sheet of paper or a sequence of sheets of paper. The sheets printed for a single recipient/delivery point may be inserted together into one envelope addressed to the recipient or delivery point in question. The resulting consolidated mailpiece can be mailed at a lower cost than the cost that would be incurred for separately mailing the constituent mail messages. The consolidated printing and mail production run may also produce operational savings above and beyond the savings in postage.

In a hybrid approach, the service bureau receives mail message files in electronic form from two or more mailers, and electronically consolidates the mail messages by recipient or by delivery point. The mail messages for a single recipient or delivery point are printed on a sequence of sheets of paper, but rather than being inserted in a single envelope, the same are inserted into a series of envelopes. The envelopes for a single recipient/delivery point are then outsorted together and tabbed together or otherwise secured to each other to generate a consolidated mailpiece that is similar in physical form to the consolidated mailpiece referred to above in connection with the pre-sort house approach. However, in the hybrid approach now being described, the constituent mailpieces are produced in the same mail production run, rather than having been physically produced by separate mailers.

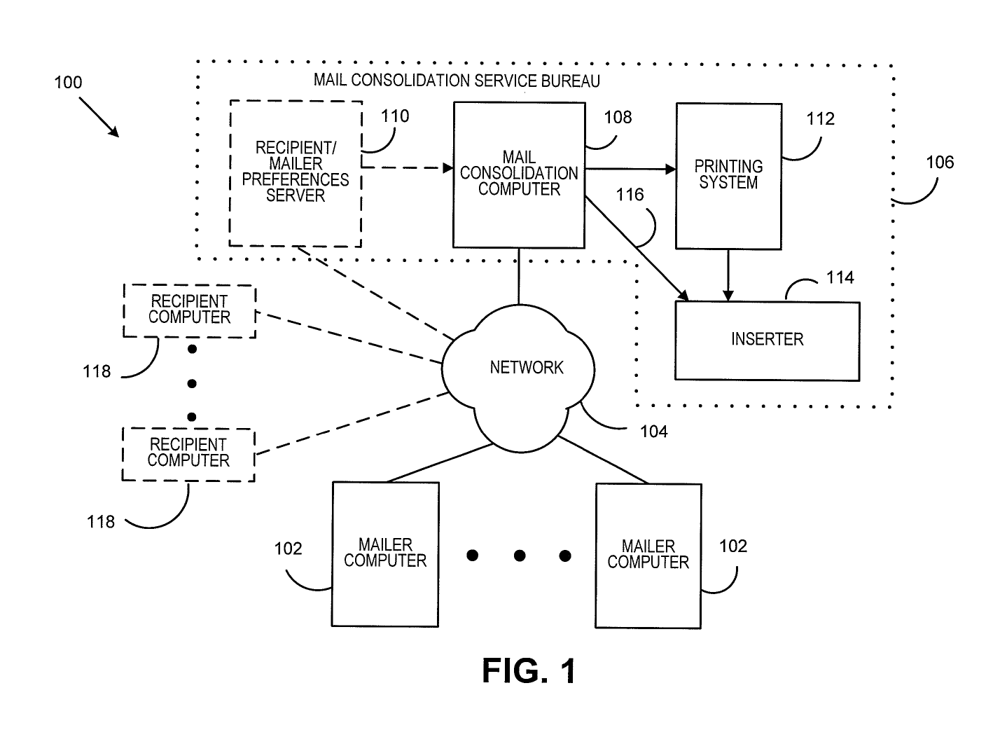

FIG. 1 is a block diagram of a system 100 provided according to some aspects of the invention. The system 100 is suitable for embodying the above-mentioned approach to the invention which primarily employs electronic consolidation of mail messages.

The system 100 includes a number of mailer computers 102. Although only two mailer computers 102 are explicitly shown in FIG. 1, it is preferable that the number of mailer computers be larger. Each mailer computer may be operated by a respective mailer. As will be appreciated from the “Summary” portion of this disclosure, the mailers may be, for example, payment card issuers, utility companies, telecommunication carriers, mortgage servicing companies (which term may include mortgage lenders that service mortgages that they hold), brokerage firms, insurance companies, taxing authorities or any other entity that has a need to send communications by mail to mail recipients on a regular basis. In the case of many mailers, the communications to be sent may include monthly account statements. Such communications fall within the definition of the above-mentioned term, “mail message”.

In general, the greater the number of mailers participating in the system, the greater will be the opportunities for savings of postage and other costs by consolidating mail messages to each recipient or delivery point. Thus in general it is preferable that the number of mailers, and hence the number of mailer computers, be relatively large, to lead to multiple mailpieces per recipient.

Each mailer computer may operate to generate (e.g., on a regular basis) an electronic file of mail messages to be sent to mail recipients. These files may be similar to files conventionally employed for generating mail production runs. However, it may be desirable that the mail messages in each file include as a data field, and/or be tagged with, an RID as defined above, so that each mail message is associated with the intended mail recipient and to facilitate electronic sorting of the mail messages by recipient. It may also be desirable that the files produced by the mailer computers 102 be in a standardized format, or at least in compatible formats, to facilitate the consolidation of the files and printing of the consolidated files on a standardized set of printing stock.

The system 100 further includes a data communication network 104, to which the mailer computers are connected (at least from time to time as required) in order to transmit the above-mentioned electronic files of mail messages. The data communication network 104 may operate in a conventional manner. It may be preferable that data communications transmitted over the data communication network 104 be conducted in encrypted form, to protect the privacy of account statement information and the like.

The system 100 also includes a mail consolidation service bureau 106 established in accordance with aspects of the present invention. In some respects the mail consolidation service bureau 106 may embody capabilities commonly possessed by mail production facilities, but with additional capabilities, as described herein, to implement consolidation of files of mail messages that originate from unrelated sources.

The mail consolidation service bureau 106 includes a mail consolidation computer 108, which is described in more detail below. The mail consolidation computer 108 is connected to the data communication network 104 so that the mail consolidation computer 108 is able to receive electronic files of mail messages produced by and transmitted from the mailer computers 102. The mail consolidation service bureau 106 also may include, in some embodiments, a server computer 110 that may collect and store data indicative of preferences of mailers and/or mail recipients with respect to attributes of the mailpieces to be produced by the mail consolidation service bureau 106. The preferences server computer 110 may be coupled to the mail consolidation computer 108 so that the mail consolidation computer 108 has access to the data that indicates the mailers'/mail recipients' preferences. In some embodiments, the functions of the mail consolidation computer 108 and the preferences server computer 110 may be at least partially integrated into a single computer.

The mail consolidation service bureau 106 also includes a printing system 112 that is coupled to and controlled by the mail consolidation computer 108. The printing system 112 may be similar in many respects to conventional printing equipment employed for producing large mailings, but may also have certain novel capabilities as described below.

Still further, the mail consolidation service bureau 106 includes a mail inserter 114. The inserter 114 is coupled to the printing system 112 so as to receive printed sheets (or a continuous paper web) from the printing system and to insert the printed sheets (or sheets burst from the web) into envelopes to assemble mailpieces. At least some of the resulting mailpieces may include mail messages generated from unrelated mailers. The inserter 108 is also coupled to the mail consolidation computer 108 by a signal path 116. The mail consolidation computer 108 may transmit control signals via the signal path 116 for the purpose of controlling the inserter 114. The inserter may have many or all of the capabilities of a conventional large inserter, and may have additional novel capabilities as well, as described below, to allow the mail consolidation service bureau 106 to accomplish novel functions as described herein.

In some embodiments, the system 100 may be deemed to include personal computers 118 (or other computing devices such as PDAs or web-enabled cell phones) operating by mail recipients. The mail recipients' computers 118 are connected, at least from time to time, with the data communication network 104. The mail recipients' computers 118 may be operated by the mail recipients for the purpose of accessing a website hosted by the preferences server computer 110 in order to input data indicative of the mail recipients' preferences with respect to the mailpieces to be generated by the mail consolidation service bureau 106. In this respect, the system 100 may operate in a similar fashion to the system disclosed in commonly-assigned U.S. Pat. No. 7,058,586, except that the specific mail attributes selected as preferences by the mail recipients in the system 100 may be different from the types of preferences described in the '586 patent. In particular, the preferences selected by the mail recipients in the system 100 may relate to attributes of consolidated mailpieces to be produced by the mail consolidation service bureau 106, and thus may be at least somewhat different from the types of preferences described in the '586 patent. The disclosure of the '586 patent is incorporated herein by reference. The types of preferences that may be selectable by the mail recipients in connection with the system 100 are described below. Reference is also made to commonly assigned U.S. Pat. Nos. 6,717,957 and 6,782,415, both of which are concerned with sending messages to recipients in accordance with the recipients' preferences.

As an alternative to the website hosted by the preferences server computer 110, or in addition thereto, the mail consolidation service bureau 106 may include or may have associated therewith an interactive voice response (IVR) system (not separately shown) which the mail recipients may telephone into in order to select preferences with respect to the mailpieces to be produced by the mail consolidation service bureau 106.

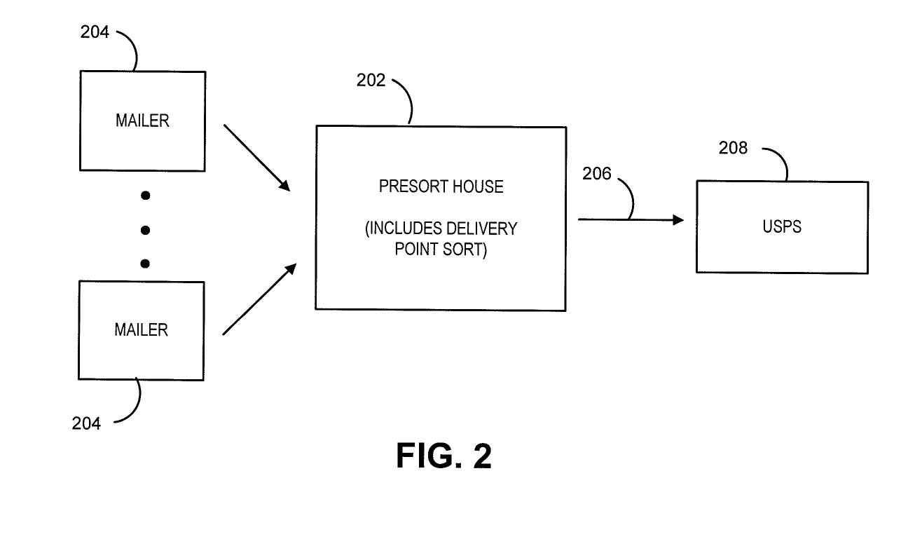

FIG. 2 schematically illustrates another aspect of the invention, namely an approach to consolidation of mailpieces which relies primarily on physical sortation. FIG. 2 shows a presort house 202, which may include essentially conventional automatic letter sorting equipment (not separately shown). In an essentially conventional manner the sorting equipment reads POSTNET barcodes on the letters to direct the letters to the appropriate sorting bins. However, as will be discussed in detail below, instead of just sorting the mail to the 3-digit or 5-digit ZIP code level, the sorting equipment may operate to sort at least some of the mail to the delivery point, using all digits of a 9- or 11-digit ZIP code. Further, there is an additional module (not shown in FIG. 2) associated with or included in the sorting equipment to tab together groups of mailpieces that are addressed to the same delivery point and that have been brought together via the sortation process.

FIG. 2 also shows a number of mailing organizations 204 that supply batches of mail to the presort house 202 for presorting to obtain postal rate discounts. Through the tabbing together of mailpieces that have a common delivery point, the presort house provides what are in effect even greater postage discounts than those provided by the USPS “worksharing” discounts.

Arrow 206 in FIG. 2 represents the presort house 202 inducting combined mailings into the USPS 208. The combined mailings are consolidated from the individual mail batches received from the mailing organizations 204, and include consolidated mailpieces formed by tabbing together constituent mailpieces that share a destination delivery point.

Having provided an overview of the two primary approaches to mailpiece consolidation according to aspects of the invention, the discussion will now return to the system 100 and the mail consolidation service bureau 106 that was discussed above.

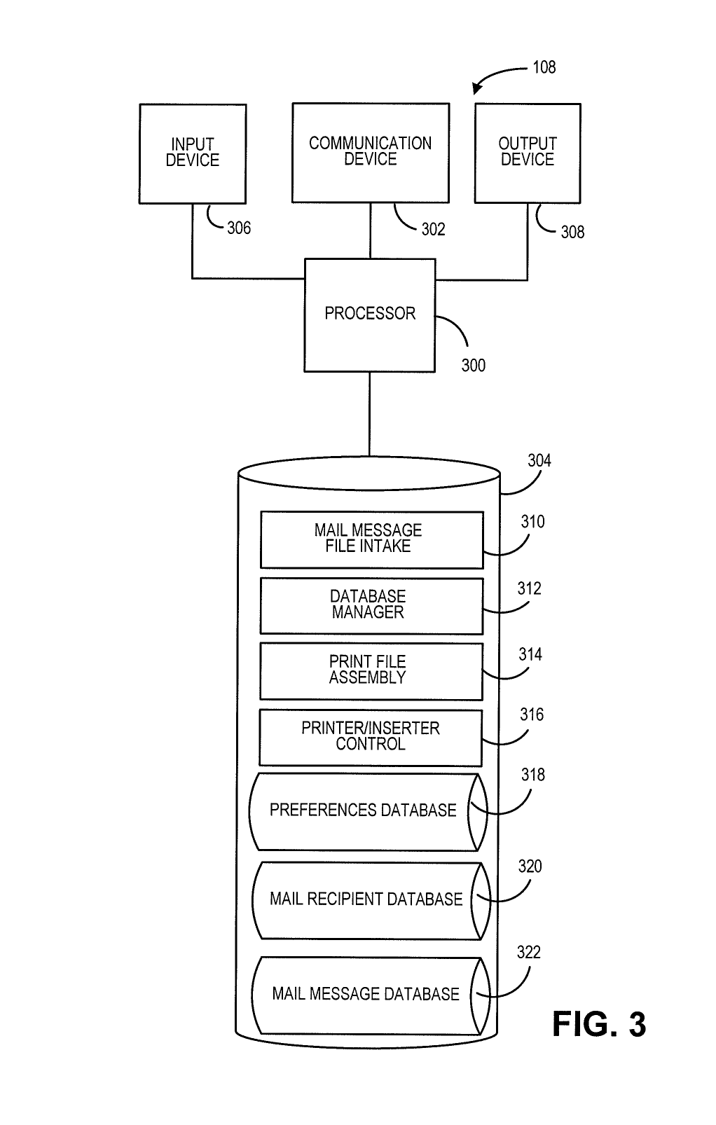

FIG. 3 is a block diagram of the mail consolidation computer 108 that is part of the mail consolidation service bureau 106 shown in FIG. 1.

As depicted, the mail consolidation computer 108 includes a computer processor 300 operatively coupled to a communication device 302, a storage device 304, one or more input devices 306 and one or more output devices 308.

Communication device 302 may be used to facilitate communication with, for example, other devices (such as the preferences server computer 110 (if present), the printing system 112 and the inserter 114). The input device(s) 306 may comprise, for example, a keyboard, a keypad, a mouse or other pointing device, a microphone, knob or a switch, an infra-red (IR) port, a docking station, and/or a touch screen. The input device(s) 306 may be used, for example, to enter information. Output device(s) 308 may comprise, for example, a display (e.g., a display screen), a speaker, and/or a printer (the printing system 112—FIG. 1—may also be considered to be an output device).

Continuing to refer to FIG. 3, storage device 304 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. At least some of these devices may be considered computer-readable storage media, or may include such media.

In some embodiments, the hardware aspects of the mail consolidation computer 108 may be entirely conventional.

Storage device 304 stores one or more programs or portions of programs (at least some of which being indicated by blocks 310-316) for controlling processor 300. Processor 300 performs instructions of the programs, and thereby operates in accordance with the present invention. In some embodiments, the programs may include a program or program module 310 that programs the mail consolidation computer 108 to receive electronic files of mail messages from the mailer computers 102 shown in FIG. 1.

Continuing to refer to FIG. 3, the storage device 304 may also store a conventional database manager program 312. The database manager program 312 may program the mail consolidation computer 108 so that the mail consolidation computer 108 is able to maintain and access a number of databases.

Still another program or program module stored on the storage device 304 is indicated at block 314. Program/module 314 controls the mail consolidation computer 108 to generate print files for a mail production run in such a manner that mail messages originating from different mailers and intended for the same recipient or delivery point are electronically sorted together. The resulting print files facilitate consolidation of plural mail messages into a single consolidated mailpiece. Program module 314 is provided in accordance with aspects of the present invention. Details of the functions provided by the program module 314 are provided below.

Storage device 304 also stores a program/program module 316, which operates to control the mail consolidation computer 108 to control the printing system 112 (FIG. 1) and the inserter 114 to produce mailings based on the print files, and in such a manner that the mailings include consolidated mailpieces.

There may also be stored in the storage device 304 other software, such as one or more conventional operating systems, device drivers, communications software, etc.

Still further, the storage device 304 may store various databases that are employed in connection with mail production. Such databases may include a database 318 that stores recipients' and/or mailers' preferences with respect to the mailpieces to be produced by the mail consolidation service bureau 106. Another database that may be stored in the storage device 304 is a mail recipient database 320. The mail recipient database 320 may store information concerning mail recipients, such as their RIDs and the delivery points (indicated by DIDs) for the mail recipients. (In some embodiments, the databases 318 and 320 may be combined.)

The storage device 304 further stores a mail message database 322. The mail message database 322 stores the mail messages contained in the electronic files received from the mailer computers 102 (FIG. 1).

The storage device 304 may also store other databases that may be useful for the functions of generating the mail production runs described herein.

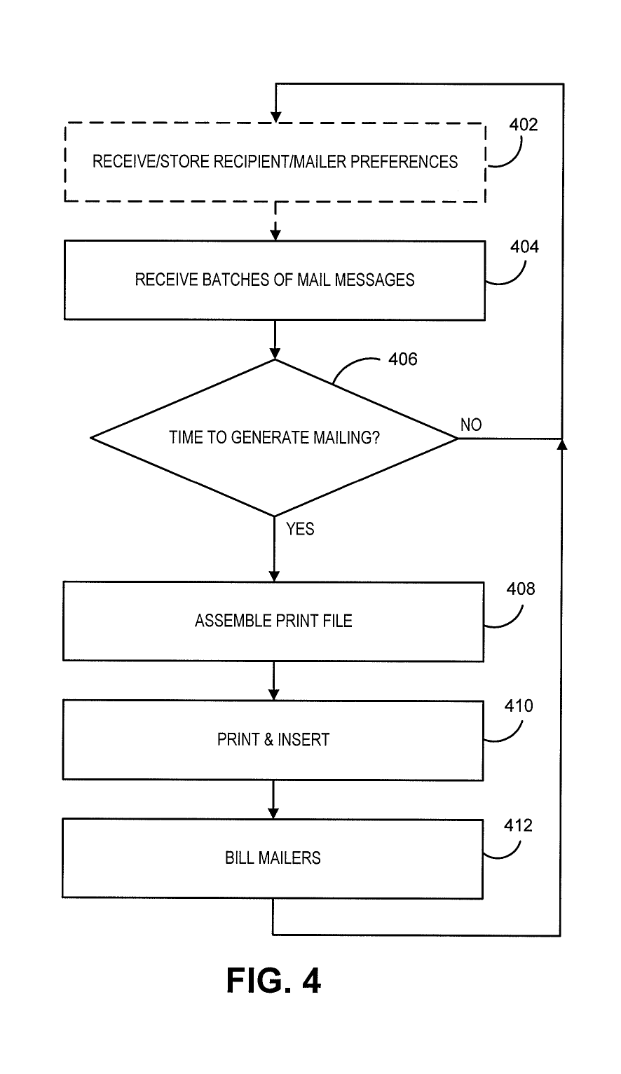

FIG. 4 is a flow chart that illustrates a process that may be performed by or under the control of the mail consolidation computer 108.

At 402 in FIG. 4 (and if the mail consolidation service bureau 106 supports the collection and satisfaction of mailer and/or mail recipient preferences), the mail consolidation computer 108 receives and stores data provided by the mail recipients and/or the mailer as to their preferences with respect to attributes of the mailpieces to be generated by the mail consolidation service bureau 106. This function may be performed in cooperation with the preferences server computer 110.

At 404, the mail consolidation computer 108 receives, via the data communication network 104, batches (files) of mail messages generated in and transmitted from the mailer computers 102. (In addition or alternatively, the mail consolidation computer 108 may receive batches of mail messages stored on transportable data storage media that are delivered to the mail consolidation service bureau 106 from the mailers.)

At a decision block 406, the mail consolidation computer 108 determines whether the time has come to generate a consolidated printing file for a mail production run. The time for generating the consolidated printing file may be set on a fixed basis (e.g., at a certain time each business day), or may be a function of when a sufficient density of files of mail messages has been received to obtain a desired level of postage savings. In the latter cases, there may still be deadlines to trigger the mail production process so that there is not too long a delay between receiving an electronic file of mail messages and consolidation of the mail messages from that file into a mail production run.

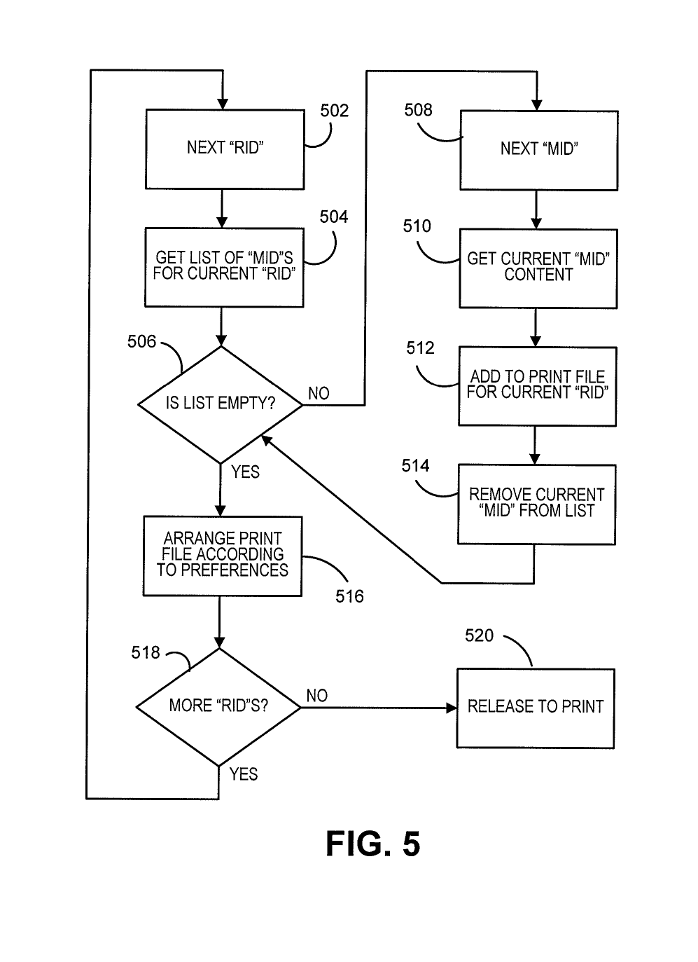

If it is determined at decision block 406 that it is not time to generate a printing file, then the process of FIG. 4 continues with the activities of blocks 402 (if supported) and 404. However, if the mail consolidation computer 108 determines that it is time to generate a printing file, then the process of FIG. 4 advances from decision block 406 to block 408. At block 408, the mail consolidation computer 108 generates a print file from which it will drive a mail production print run. In doing so, the mail consolidation computer 108 collects and orders mail messages included in the electronic files received at 404. Details of an example of block 408 are illustrated in the flow chart shown in FIG. 5.

At 502 in FIG. 5, the mail consolidation computer 108 accesses the next (or first) recipient identification code (RID) in a list of recipients for whom mail messages have been received at 404. Then, at 504, the mail consolidation computer 108 accesses a list of all mailer identification codes (MIDs) corresponding to mailers from whom there are pending mail messages for the current RID.

Decision block 506 follows block 504. At decision block 506 the mail consolidation computer 108 determines whether the list of MIDs for the current RID is empty. If the list of MIDs is not empty, then the process of FIG. 5 advances from decision block 506 to block 508. At block 508, the mail consolidation computer 108 accesses a database entry for the next (or first) MID on the list of MIDs for the current RID. Using this database entry, the mail consolidation computer 108 accesses (block 510) the current mail message for the RID (i.e., for the mail recipient who corresponds to the current RID), and then adds (block 512) the current mail message to the print file for the current RID. At this point, the mail consolidation computer 108 removes (block 514) the current MID from the list of MIDs for the current RID. The process then loops back to decision block 506 to repeat the loop of 508-514 if necessary.

The effect of the loop of 508-514 is to bring together in electronic form all currently stored mail messages for the current RID. The mail messages for a single RID (mail recipient) are thus queued or sequenced together in the print file that will be used to generate the print run. It is assumed that at least in some cases there are mail messages pending for delivery to the RID from two or more different mailers, so that in such cases two or more mail messages in electronic form are sorted together for sequential inclusion in the print file.

If it is determined at decision block 506 that the list of MIDs for the current RID is empty, then the process of FIG. 5 advances from decision block 506 to block 516. At 516 the mail consolidation computer 108 may arrange or rearrange the print file for the current RID in accordance with stored preferences selected by either or both of the current mail recipient or the mailers in question. This assumes that the mail consolidation service bureau 106 is operable to collect and respond to recipient/mailer preferences. Alternatively, however, the mail consolidation computer 108 may simply apply preset uniform rules for arranging the mail messages in a certain order, or the mail messages may be left in the order in which they were added at the various iterations of step 512. (In another embodiment, rules and/or preferences are applied at each iteration of step 512.) Examples of mailer and/or recipient preferences and execution of the same by the mail consolidation service bureau 106 will be described below.

Following block 516 is a decision block 518. At decision block 518, the mail consolidation computer 108 determines whether there are any more RIDs (mail recipients) for which current mail messages are to be collected. If so, the process loops back from decision block 518 to block 502, so that the process of steps 504-516 is carried out for the next RID.

If at decision block 518 the mail consolidation computer 108 determines that there are no more RIDs for which mail messages are to be collected, then the process advances from decision block 518 to block 520. At block 520, the print file is released for printing of the contents of the consolidated mailing. (However, in some embodiments, printing of the print file may be at least partially overlapped with the assembling of the print file as illustrated in FIG. 5.)

In some embodiments, prior to releasing the print file, the mail consolidation computer 108 may generate an index that lists the mail messages to be sent in the current consolidated mailpiece that is being assembled for the recipient in question. The index may be printed on a separate sheet of paper from the mail messages or may share a sheet of paper with at least one of the mail messages. The index may be inserted into a consolidated envelope with two or more mail messages, and thus ends up being contained in the resulting consolidated mailpiece with two or more printed mail messages. The index may serve as a table of contents, or guide to aid the recipient in understanding what mail messages are contained in the consolidated mailpiece.

In an alternative embodiment, the mail consolidation computer 108 may send the index to the recipient in electronic form (e.g., via electronic mail). This may be done in addition to or in place of including a printed index in the consolidated mailpiece. In addition to listing the mail messages that are included in the consolidated mailpiece, the index/e-mail message may indicate the date on which the consolidated mailpiece is expected to be delivered to the recipient.

It may be a matter of the recipient's preference as to whether he/she receives an index to the consolidated mailpiece, and if so, whether in printed form, in electronic form, or both.

In some embodiments, the process of FIG. 5 is carried out with respect to every mail recipient/RID for which the mail consolidation service bureau 106 has a record. However, alternatively, as batches of mail messages are received from mailers at 404 in FIG. 4, the mail consolidation computer 108 may scan the incoming mail messages for RIDs and may build a list of RIDs for which mail messages are pending. As part of the same process, the mail consolidation computer 108 may build, for each RID on that list, a list of the MIDs from whom mail messages are pending for the RID in question. The latter lists may be used at 504, 506 and 508 in FIG. 5, as described above.

Referring once again to FIG. 4, in the process depicted in that drawing, step 410 follows (or in some embodiments overlaps with) step 408. At step 410, the mail consolidation computer 108 controls the printing system 112 and the inserter 114 so that the print file assembled at 408 is printed on paper, and paper sheets with the mail messages printed thereon are inserted into envelopes to create mailpieces. The printing may be on cut sheets of paper, or on a paper web which is subsequently burst or cut to form sheets. Because of the manner in which the print file was assembled, all mail messages for a single mail recipient are printed one after the other (on one or more sheets), so that the sheets with the mail messages for that recipient may be inserted together into a single envelope to form a consolidated mailpiece. The number of mail messages printed in the print run for a given mail recipient may range from one to eight or ten or more. (In an alternative embodiment to be described in more detail below, the mail messages for a recipient may be printed one after the other, but the resulting printed sheets may be inserted in more than one envelope in a group of sequentially adjacent envelopes. In still another alternative, all mail messages which share a given destination delivery point may be printed one after the other and inserted either in one common envelope or in more than one envelope in a group of sequentially adjacent envelopes.)

It may be desirable that the number of mail messages included in a consolidated mailpiece be limited so that the consolidated mailpiece not exceed a given thickness, such as one-quarter inch.

The printing of the mail messages may be done in such a manner as to aid the recipient in distinguishing where one mail message ends and the next begins. In one example, the printing may include a distinctive printed divider indication (e.g., in a contrasting color) to mark a boundary between adjacent mail messages. In addition, or alternatively, the messages themselves may be printed in contrasting typefaces, formats and/or colors.

More details on the structure and contents of examples of the consolidated mailpieces produced at 410 will be described below.

In process steps not explicitly shown in FIG. 4, the mailpieces produced at 410 may be processed through a postage meter/mailing machine to affix evidence of postage payment to the mailpieces. Alternatively, a manifest of the mailing may be prepared to allow for induction of the mailing into the USPS according to a permit mail process. In either case, induction of the mailing into the USPS follows.

In some embodiments, each mailpiece may be weighed as part of determining the postage charge applicable to the mailpiece in question. However, in other embodiments, the mail consolidation computer 108 may track the number of printed sheets, envelopes and inserts included in each mailpiece and may calculate the weight of the mailpiece based on known weights of the constituent components of the mailpiece.

FIG. 4 also shows a block 412, at which the mail consolidation computer 108 generates bills for the mailers to pay in respect of the mailing services provided by the mail consolidation service bureau 106. The bills may be rendered on a per mail message basis, but may vary from mail message to mail message depending on a number of factors such as the amount of printing required for the mail message, the extent to which savings in printing, material costs, processing effort and postage could be realized by consolidating the mail message with mail messages that originated from other mailers. It is believed that the mailing charges assessed at 412 may exhibit substantial savings relative to conventional mail production practices. One factor in such savings may be reduced postage costs arising from consolidation of two or more mail messages into a single consolidated mailpiece.

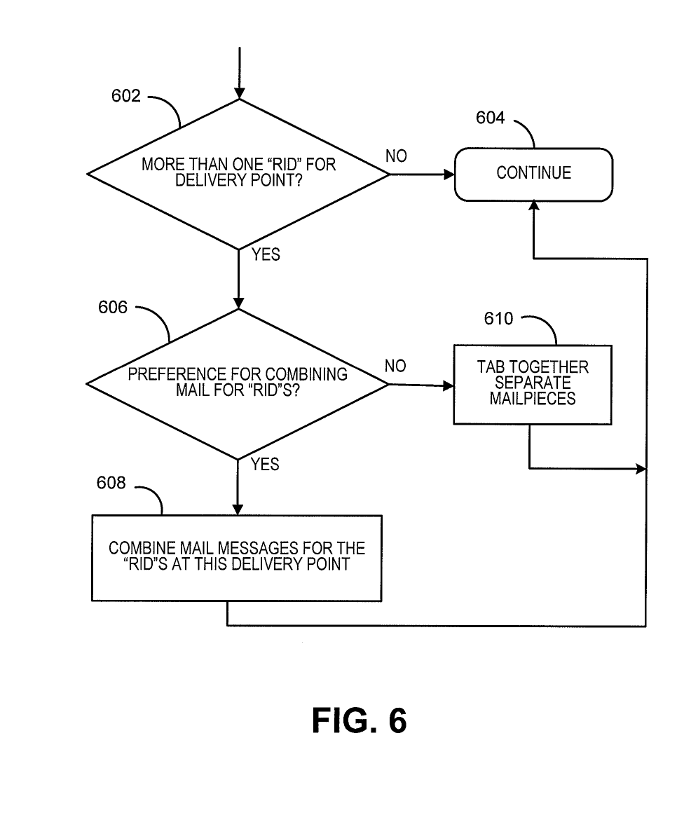

At this point further consideration will be given to block 516 in FIG. 5, and to the subject of mail recipients' preferences. Prior to a more complete discussion of the subject of preferences, including a discussion of how mail recipients may be enabled to make their preferences known to the mail consolidation service bureau 106, there will first be a discussion of mail recipients' preferences in regard to combining mail intended for different recipients who reside at the same mailing address. In this regard, FIG. 6 is a flow chart that illustrates further aspects of the process of FIG. 5.

At 602 in FIG. 6, it is determined whether there is more than one RID (and hence more than one mail recipient) associated with a particular delivery point for which mail messages have been received in the batches of mail messages received at 404 in FIG. 4. If not, then the process of FIG. 5 continues (604, FIG. 6) as described above without any need to address the possible issue of multiple recipients at the delivery point. However, if a positive determination is made at 602 (i.e., if it is determined that there are mail messages to be delivered to more than one recipient at the delivery point), then decision block 606 follows decision block 602.

At decision block 606 it is determined whether the mail recipients at the delivery point in question have indicated a preference for having their mail messages combined into a single mailpiece. If so, then the mail messages, in electronic form, are arranged within the print file in such a manner that the mail messages may be printed together and inserted into a single envelope, thus combining the mail messages, as indicated at 608. After step 608 in complete then the process of FIG. 5 continue step 604.

However, if at 606 it is determined that the recipients at the delivery point have not indicated that their mail messages are to be combined, then 610 follows decision block 606. At 610, the mail messages for each recipient at the delivery point are segregated from each other, by printing first all the mail messages for one recipient, then the mail messages for the next recipient at the delivery point, and so on until all the mail messages for the recipients at the delivery point are printed. Further, all the printed mail messages for the first recipient at the delivery point are inserted into one envelope, then the mail messages for the next recipient are inserted into the next envelope, and so forth. Still further, the envelopes that correspond to the mail recipients at the delivery point are grouped together, and then optionally physically secured together (e.g., by applying adhesive tabs to the envelopes) to produce a consolidated mailpiece for the delivery point that includes a separate envelope for each mail recipient at the delivery point. After step 610 is complete then the process of FIG. 5 continue step 604.

To allow for tabbing together of envelopes, the inserter 114 may include a tabbing module, which is not separately shown. The tabbing module may adapt conventional techniques for causing folded one-sheet mailpieces to be tabbed closed, and may apply such techniques to tabbing together envelopes (each containing one or more mail messages) in order to physically secure the envelopes together to form a consolidated mailpiece therefrom. This may also be done, as described below, to consolidate envelopes that all contain mail messages for the same recipient.

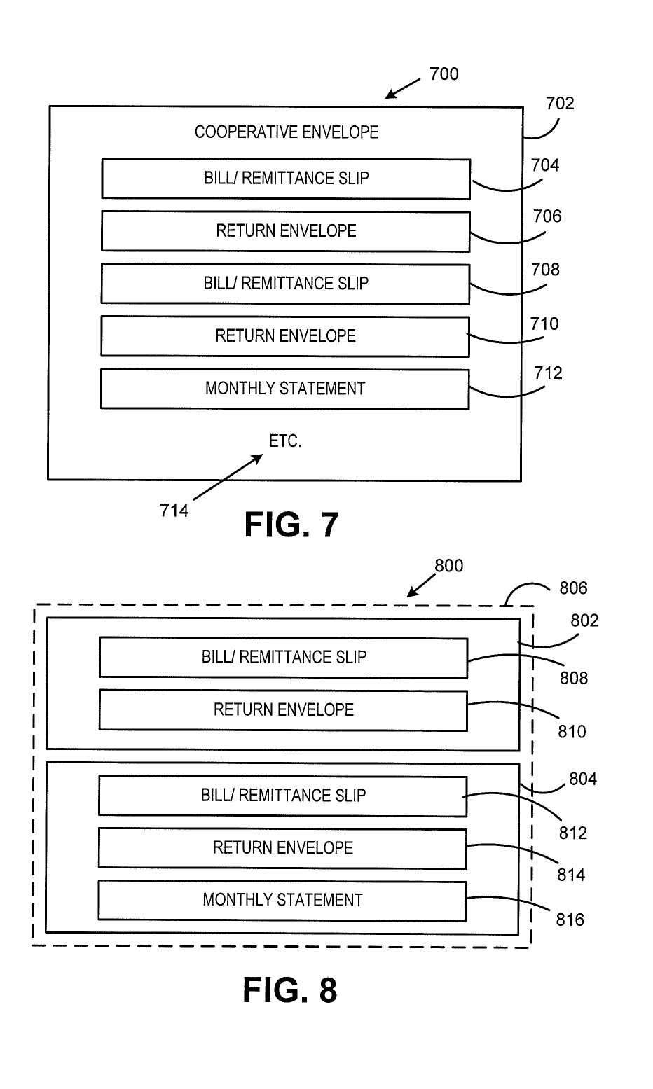

FIGS. 7 and 8 schematically illustrate examples of consolidated mailpieces that may be produced by the mail consolidation service bureau 106. FIG. 7 shows an example mailpiece 700, which includes an outer envelope 702. (Outer envelope 702 may be referred to as a “cooperative envelope” in the sense that it may include mail messages originating from several mailers who, via the mail consolidation service bureau 106, are cooperating in their mailings to the recipient of the mail messages.) The mailpiece 700 may include several mail messages that are all addressed to the same recipient. Alternatively, if the mail recipients at a single delivery point have so elected by their indicated preferences, the mailpiece 700 may include mail messages for more than one recipient at a single delivery point.

More specifically, the outer envelope 702 may contain a bill 704 that originated from a first mailer. The bill 704 may include a first remittance slip (not separately indicated) which may be separable from the bill 704 via a perforation (not shown). The first remittance slip may be intended to be inserted by the recipient in a return envelope 706 with the recipient's check in payment of the bill 704. It will be noted that the return envelope 706 is also indicated as being contained within the outer envelope 702. It may be the case, for example, in accordance with conventional practices, that the return envelope 706 is a window envelope, and that the first remittance slip includes a pre-printed address for the first mailer's payment receiving operation. When the first remittance slip is properly inserted (by the mail recipient) in the return envelope 706, the pre-printed address for the first mailer shows through the window in the return envelope to serve as the mailing address for the return envelope.

The outer envelope 702 may also contain a bill 708 that originated from a second mailer that is different from the first mailer. Like the bill 704, the bill 708 may include a remittance slip (hereinafter referred to as the second remittance slip) which may be separable from the bill 708 via a perforation. The second remittance slip may be intended to be inserted by the recipient in a return envelope 710 (also contained in the outer envelope 702). It is also intended that the recipient insert his/her check in payment of the bill 708 in the return envelope 710 with the second remittance slip.

The outer envelope 702 also contains a monthly statement 712 that originated from a third mailer that is different from the first and second mailers. The monthly statement 712 may just be a statement of account (e.g., for a checking account or a brokerage account), and not a bill. Although FIG. 7 suggests that the bill/remittance slip 704, the bill/remittance slip 708 and the monthly statement 712 are all printed on separate sheets of paper, such need not necessarily be the case. For example, the bill, 708 and the monthly statement 712 may be on the same sheet of paper, though still constituting separate mail messages in terms of content. In such a sheet, the format of the printing on the common sheet of paper may be such as to clearly present the mail messages on the sheet as being separate messages. Each of the bill 704, the bill 708 and the monthly statement 712 may take up one or more sheets of paper.

The mailers referred to in connection with this example mailpiece 700 may be any type of entity that is accustomed to sending bills or monthly statements to an account holder. For example, the first mailer may be a utility company and the second mailer may be a payment card issuer. The third mailer may be a brokerage firm. Other example mailers may include insurance companies, retail banks, issuers of private label (store) credit cards, telecommunications companies, mortgage servicing companies, taxing authorities (e.g., a local municipality or school district).

Each of the bill 704, the bill 708 and the monthly statement 712 may have originated in electronic form and may have been received as part of a respective batch of mail messages received electronically by the mail consolidation service bureau 106 from a respective mailer. The bill 704, the bill 708 and the monthly statement 712 may continue to be regarded as mail messages when in their printed form both prior to insertion in the outer envelope 702 and after insertion therein.

As indicated at 714, the outer envelope 702 may contain additional mail messages besides the three mail messages that are explicitly shown. The number of mail messages in the outer envelope 702 may be any number, including one, two, four or more. It need not necessarily be the case that all of the mail messages included in the mailpiece 700 are bills or monthly statements. In fact, it need not be the case that any of the mail messages be bills or monthly statements. In some cases, some or all of the mail messages may be solicitations or advertisements. Some mail messages may include a check. Some materials contained in the mailpiece 700 may be pre-printed advertising material that did not originate as a mail message in electronic form specifically intended for delivery to the mail recipient for mail messages included in the mailpiece 700. Some of the mail messages may be occasional notices or the like, or may be statements presented at a regular interval other than monthly.

The name and address of the mail recipient may be printed on a front surface of the envelope 702. In a case where the mailpiece 700 combines mail messages for more than one recipient at the same delivery point, all of the recipients' names, or one or less than all of the recipients' names, may be printed on the front surface of the envelope 702. The envelope 702 may also include a postage meter stamp printed on the front surface to evidence payment of postage for the mailpiece. Alternatively, postage may be paid via a manifesting arrangement pursuant to permit mailing practices.

In some embodiments, the outer envelope 702 may contain distinctive printing (e.g., a colored and/or patterned border) and/or may be of a distinctive color to aid the mail recipient in recognizing that this mailpiece 700 is important and contains a number of bills or other documents that require attention from the mail recipient. In some embodiments, the mail consolidation service bureau 106 may obtain trademark protection for the appearance of the outer envelope 702 to keep other entities from imitating the appearance of the outer envelope 702. This too may help the mailpiece 700 to stand out from the recipients' other mail and may help to command the mail recipient's attention for the mailpiece 700. It may be the case that the mail recipient receives most or all of his/her important mail messages via the “cooperative envelope” from the mail consolidation service bureau 106. If so, and if the outer envelope is distinctive, as indicated in this paragraph, it may be a significant convenience for the mail recipient to have most or all of his/her important mail arrive in an easily recognized, consolidated mailpiece.

In some embodiments, the cooperation among the mailers may extend to having the mail consolidation service bureau 106 provide a consolidated payment processing service and print a consolidated remittance slip (for inclusion in the mailpiece 700) in order to allow the mail recipient to pay two or more bills, included in the mailpiece 700, with a single check. The consolidated remittance slip may be addressed to the payment processing operation run by the mail consolidation service bureau 106 on behalf of participating mailers. The mail recipient's check may be collected by the mail consolidation service bureau 106, which may then remit to the mailers the amounts due to each mailer from the mail recipient. In some embodiments, the consolidated remittance slip may allow the mail recipient to make partial payment of the total of the bills due and to allocate the payment represented by the mail recipient's check among the bills due from the participating mailers.

In some embodiments, the mail consolidation service bureau 106 may print on the outside of the cooperative envelope 702 logos or other information to identify some or all of the mailers whose mail messages for the recipient are included in the mailpiece 700. This may be done in a manner that is similar to the printing of advertising messages on the outside of an envelope, as proposed in commonly assigned U.S. Pat. No. 6,173,274. In addition or alternatively, the mail consolidation service bureau 106 may print advertising messages on the outside of the cooperative envelope 702.

In some embodiments, the consolidated mailpieces may include administrative or other informational notices generated by the mail consolidation service bureau 106 and not based on any mail message generated by a participating mailer.

In some embodiments, the mail consolidation service bureau 106 may encourage the mailers (or may take concrete steps to facilitate coordination among the mailers) so that the mailers' mail messages to given sets of mail recipients are concentrated in a given daily or nightly processing cycle in order to maximize the opportunities for consolidation of mail messages among the mailers.

It may be desirable that all the return envelopes in a consolidated mailpiece be of the same size and format, and that all of the remittance slips be of the same size and format, so that each return envelope may be used interchangeably with any remittance slip. In some embodiments, if the return envelopes are not interchangeable, it may be desirable to color code the return envelopes and the remittance slips, or otherwise to mark them, to aid the recipient in matching remittance slips with return envelopes.

FIG. 8 shows another example mailpiece 800 that may be produced by the mail consolidation service bureau 106.

The mailpiece 800 includes an outer envelope 802 and another outer envelope 804. Reference numeral 806 schematically indicates some manner of physically securing the envelopes 802 and 804 together in such a manner that the envelopes may be sorted, handled and delivered as a single mailpiece. For example, the securing mechanism 806 may take the form of adhesive tabs adhered to both of the envelopes 802, 804. The tabs may be similar to the type of tab conventionally employed to close an open side of a single sheet folded mailpiece. In some embodiments, the envelopes 802 and 804 are of the same size and shape, and four tabs are employed, one at each edge of the envelopes. In other embodiments, more or fewer than four tabs may form the securing mechanism 806.

An alternative securing mechanism may include a paper or plastic band that secures the envelopes 802, 804 to each other. If the band is plastic, it may be transparent so as to permit reading of an address printed on one of the envelopes, in the case where the band overlays the address. In another alternative, the securing mechanism is an outermost envelope into which both envelopes 802, 804 are inserted, with the outermost envelope sealed to contain the envelopes 802, 804 within. The outermost envelope may be transparent to allow an address on one of the envelopes 802, 804 to be visible. Alternatively, the recipient's address may be printed on the outermost envelope.

Where the envelopes 802 and 804 are tabbed or banded together, it may be the case that only the upper one of the two envelopes may bear a postage meter stamp, or a permit mailing indicium.

The envelope 802 may contain a bill/remittance slip 808 and a return envelope 810, which may be like the bill/remittance slip 704 and the return envelope 706 discussed above in connection with FIG. 7. The envelope 804 may contain a bill/remittance slip 812, a return envelope 814 and a monthly statement 816, which may be like the bill/remittance slip 708, return envelope 710 and the monthly statement 712 discussed above in connection with FIG. 7. That is, for example, the bill/remittance slip 708 and the monthly statement 712 may be separate mail messages that originated in electronic form from two different mailers.

The number of mail messages included in each of the envelopes 802, 804 may be one, two or another number. The number of outer envelopes consolidated into the mailpiece 800 by tabbing, banding, inclusion in an outermost envelope or the like may be two, three or any other number. In some embodiments, all mail messages in envelope 802 are for one recipient, and all mail messages in envelope 804 are for a different recipient who shares the same mailing address with the first recipient. If this is the case, the envelope 802 may have the first recipient's name printed thereon and the envelope 804 may have the second recipient's name printed thereon. This arrangement may alleviate any concerns with respect to the mail recipients' privacy in regard to consolidation of mail messages intended for delivery to the same address.

In some embodiments, the mail consolidation computer 108 may be programmed to print mail messages for a given recipient (or for two or more recipients at the same address), and may select the number of envelopes in which the messages are to be inserted and tabbed or otherwise secured together. For example, the number of envelopes to be tabbed together may be equal to the number of remittance slips and return envelopes to be delivered in the consolidated mailpiece, with one and only one remittance slip and return envelope in each of the envelopes to be tabbed together. One or more other mail messages and/or advertising material or the like may also be included in each of the outer envelopes. In some embodiments, each mail message that includes a remittance slip is in an outer envelope without any other mail message included therein.

In some embodiments, the mail consolidation computer 108 may prepare an index for each consolidated mailpiece. The mail consolidation computer 108 may, for example, print the index on a sheet of paper that is enclosed with the consolidated mailpiece and/or may print the index on the outside of the envelope (or on the front of the top envelope or on the back of the rear envelope, if the consolidated mailpiece includes more than one envelope secured together). If the consolidated mailpiece includes mail messages for more than one recipient, the mail consolidation computer 108 may prepare and enclose a separate index for each recipient listing the mail messages for that recipient that are included in the consolidated mailpiece. In addition or alternatively, the mail consolidation computer 108 may send the mailpiece indexes to the recipients by electronic mail.

Against this background, there will now be discussed the subject of mail recipients' preferences with respect to consolidated mail messages generated by the mail consolidation service bureau 106.

Previous discussion in this disclosure has mentioned a preferences server computer 110 that may be operated by or on behalf of the mail consolidation service bureau 106. The preferences server computer 110 may host a website that is accessible by mail recipients via their recipient computers 118 or other web-browser-enabled devices. For example, each recipient may have his/her own account maintained via the preferences server computer 110; the recipient's account number may, for example, be his/her RID. (It may be preferred in some embodiments that the recipients not be required to have an account on the preferences server computer 110. Such recipients still may receive consolidated mailpieces via the mail consolidation service bureau 106—assuming that mailers send mail messages for them via the mail consolidation service bureau 106—but such recipients may not be able to express their preferences, and have their preferences implemented, with respect to the consolidated mailpieces.) Each recipient's account may, for example, be constituted by a database record in the preferences server computer 110 and/or in the mail consolidation computer 108. The basic information in the recipient's record may include his/her RID, and his/her mailing address. The latter may include a 9- or 11-digit ZIP code or other DID. It may not be necessary for the recipient to know and to enter his/her DID since the same likely can be readily derived from his/her street address with access to a suitable address database.

The database record for at least some recipients may also include demographic information concerning the recipients.

Other information in the recipient's record, or accessible via the recipient's record, may include the RID(s) of any other recipient(s) who share(s) the recipient's DID.

Other information in the recipient's record may indicate the recipient's preferences with respect to the mailpieces he/she is to receive from the mail consolidation service bureau 106. One preference, alluded to above, may indicate whether the recipient wishes to have mail messages addressed to him/her combined in a single mailpiece with mail messages addressed to another recipient or recipients at the same mailing address. For example, a married couple may customarily have one member of the couple pay all bills for the household, regardless of whether the accounts are in that member's name or in the other member's name. In such a case, both recipients may indicate a preference for combining their mail messages into a single envelope. In another example, two members of a couple may maintain separate financial affairs and may wish to have privacy with respect to their financial affairs. In that case, they may indicate preferences that their mail messages not be combined into a single mailpiece, or at least not be inserted into a common envelope. In some embodiments, the mail consolidation service bureau 106 may operate under a default condition such that, in the absence of indicated preferences from the mail recipients, or if either or both have not requested insertion of their mail messages into one envelope, mail messages to different recipients at the same address will be inserted into separate envelopes that will be tabbed together (or otherwise secured together) to form a consolidated mailpiece.

For some couples, there may be no concern as between themselves as to privacy of their mail messages, but they may have agreed to a division of labor (or of finances) such that one member of the couple pays certain bills each month, and the other member pays other bills. To aid in implementing this division of labor or finances, the recipients' preferences may call for the mail consolidation service bureau 106 to insert all of the first group of bills into an envelope for the first member of the couple and to insert all of the second group of bills into a separate envelope for the second member of the couple. The two envelopes may then be tabbed together (or otherwise secured) so as to form a consolidated mailpiece addressed to the couple's residence address. There may be mail messages addressed to each of the members of the couple in each of the two envelopes.

The mail recipients' preferences may also indicate in what order in a mailpiece the mail messages are to be presented. For example, their preferences may indicate that all mail messages for one recipient are to precede all mail messages for another recipient. A third recipient's mail messages may then follow the second recipient's mail messages, and so forth. This ordering may apply whether the mail messages are to be inserted in a common envelope, or whether separate envelopes—tabbed together—are provided for the mail messages of each recipient.

In addition or alternatively, a mail recipient's preferences (or shared preferences of plural recipients at the same address) may call for the order in which mail messages are presented in the mail piece to be based on the identity of the mailer and/or the type of information. For example, a mail recipient may indicate that the mail messages are to be in the following order: utility bills first, followed by the monthly mortgage statement, followed by credit card bills, followed by telecommunication services bills, followed by all other bills, followed by monthly statements that do not include a bill, followed by all other mail. Of course, many other ordering sequences are possible, and other types of mail may be listed in an ordering sequence based on type of mail. In some embodiments, the mail recipient may indicate the order in which mail messages are to be presented by the names of the specific mailing entities.

It will be recalled that, in some embodiments, the mail consolidation service bureau 106 may provide a consolidated payment processing service for at least some of the mailers. However, it may be a preference selectable by the mail recipient as to whether the mail consolidation service bureau 106 does or does not provide a consolidated remittance slip in the consolidated mailpieces it sends to the recipient. For example, the mail recipient may be permitted to indicate a preference for (a) a consolidated remittance slip only; (b) a consolidated remittance slip plus account-specific remittance slips (and a corresponding number of return envelopes), so that the recipient can decide at the time of bill payment whether to use the latter or the former; or (c) account-specific remittance slips only. Thus, in effect, the mail recipient may indicate a preference as to the number of return envelopes to be included in the consolidated mailpiece.

To go further in the same direction, it may also be a user-selectable preference as to whether all mail messages are to be inserted into one cooperative envelope or whether the mail messages are to be divided among separate envelopes to be tabbed (or otherwise secured together).

Another recipient-selectable preference may indicate whether the recipient wishes to have an index to the mailpiece included in the mailpiece, and/or sent to him/her by electronic mail or not sent at all.

The mail consolidation service bureau 106 may also permit the mail recipients to indicate a preference as to whether coupons and/or as to what types of coupons are to be inserted by the mail consolidation service bureau 106 in the consolidated mailpieces that the mail consolidation service bureau 106 sends to the mail recipients.

In another possible mail recipient preference that may be supported by the mail consolidation service bureau 106, the mail recipient may select a format in which the mail messages are to be printed by the mail consolidation computer 108. For example, the mail consolidation service bureau 106 may permit the mail recipient to select among a standard format, a large print format and a Braille format for printing by the mail consolidation computer 108 of mail messages addressed to the recipient. In some embodiments, the recipient may also be permitted to select as a preference that the mail messages be copied onto a CD ROM or another type of electronic medium and sent by the mail consolidation service bureau 106 to the mail recipient in that form rather than in printed form. In some embodiments, the recipient may be permitted to indicate a preference that his/her mail messages only be printed by the mail consolidation service bureau 106 on recycled paper.

In some embodiments, recipients may be permitted to indicate a preference as to the language in which they wish to receive mail messages. For example, all mail messages may initially be generated in English, but if a recipient has indicated a preference for another language, the mail consolidation computer 108 may run an automatic language translation utility to automatically translate the recipients' mail messages into his/her preferred language, prior to printing the recipient's mail messages.

In some embodiments, a mailer may discount its fees to the mail recipient if the mail recipient selects certain preferences. For example, the mailer may charge the mail recipient $3.00 for each paper statement mailed to the recipient, but may reduce that fee by half if the mail recipient consents to having the paper statement included in a consolidated mailpiece constructed by the mail consolidation service bureau.

In some embodiments, the mail consolidation service bureau 106 may wish to keep a record (e.g., via electronic storage) of the mail messages that it forwards to the mail recipients. This may be done, for example, in connection with determining and/or executing a marketing strategy that is directed toward mail recipients and that the mail consolidation service bureau 106 may offer to carry out for mailers or other entities. However, the mail consolidation service bureau 106 may refrain from keeping records of mail messages directed to a given mail recipient unless the mail recipient indicates by one of his/her preferences that he/she has no objection.

Alternatively, at least some mail recipients may find it convenient for the mail consolidation service bureau 106 to maintain an electronic record of the mail messages (or of at least some categories of mail messages) that the mail consolidation service bureau 106 forwards to the mail recipients. That is, the mail consolidation service bureau 106 may, at a given recipient's request, serve as an electronic “filing cabinet” or archive for the recipient in question, and may allow the recipient to access the stored/archived mail messages that the mail consolidation service bureau 106 sent to the recipient. Thus, for example, the mail consolidation service bureau 106 may serve the mail recipient by maintaining a recipient-accessible electronic record of the bills that the mail recipient receives via the mail consolidation service bureau 106. In some embodiments, the mail consolidation service bureau 106 may charge the mail recipient a fee for this service. Accordingly, the mail consolidation service bureau 106 may permit each recipient to indicate a preference as to whether he/she opts to have the mail consolidation service bureau 106 store an electronic record of bills, statements and/or other mail messages directed to the recipient in question. The recipient may further indicate preferences as to specific mailers and/or types of mail messages for which the mail consolidation service bureau 106 is to perform this service for the recipient.

It will be appreciated that at least some of the types of recipient preferences described above go well beyond any of the types of recipient preferences disclosed in commonly assigned U.S. Pat. No. 7,058,586. However, the types of recipient preference described in the '586 patent may also be incorporated in the recipient preferences system described herein. For example, the mail recipient may interact with the preferences server 110 to update the mail recipient's mailing address when the mail recipient moves. That is, the mail recipient's street address and/or DID may be stored as a preference of the mail recipient.

In some embodiments, the mail consolidation service bureau 106 may allow the mail recipients to indicate preferences via a channel other than by interacting with the above-mentioned website maintained on the preferences server computer 110. For example, the mail consolidation service bureau 106 may provide an interactive voice response (IVR) system that mail recipients may access by telephone to enter their preferences via the telephone keypad. In addition or alternatively, the mail consolidation service bureau 106 may include, in at least some consolidated mailpieces it sends to the mail recipients, a printed preferences form that the recipients may fill out and return to the mail consolidation service bureau 106.

In some embodiments, the preferences server computer 110 may store mailer preferences that the mail consolidation computer 108 may take into account in generating consolidated mailpieces that include mail messages from the mailers. Most likely the number of mailers will be relatively small (at least compared to the number of mail recipients), perhaps on the order of a few hundred or a few thousand, more or less. Consequently, it may be practical or desirable that each mailer's preferences may be negotiated or otherwise determined by direct contact between the mailer's employee(s) and the employee(s) of the mail consolidation service bureau 106. For example, the mail consolidation service bureau 106 may allow mailers to bid for desirable positioning of their mail messages within a consolidated envelope.

In some embodiments, there may be a potential for conflict between recipients' preferences and mailers' preferences. (For example, a recipient may prefer that the statement from Credit Card Issuer A appear first in the consolidated mailpiece, whereas Credit Card Issuer B may have negotiated with the mail consolidation service bureau 106 to have its statement placed first.) In such cases, the mail consolidation computer 108 may arbitrate among the various applicable preferences for a given consolidated mailpiece in accordance with predetermined rules or policies. According to one possible set of policies, the recipient's preferences may always prevail over conflicting mailers' preferences, and mailer's preferences would be applied only when the recipient has not expressed any preference or has not expressed a conflicting preference. In other embodiments, recipients may be permitted to pay a fee to the mail consolidation service bureau 106 to have their preferences prevail, but would otherwise have their mailpieces arranged in accordance with the mailers' preferences.

For now, the discussion will turn away from an approach in which consolidated mailpieces are produced by a service bureau from mail messages in electronic form, and will henceforth focus primarily on creation of consolidated mailpieces in the environment of a pre-sort house.

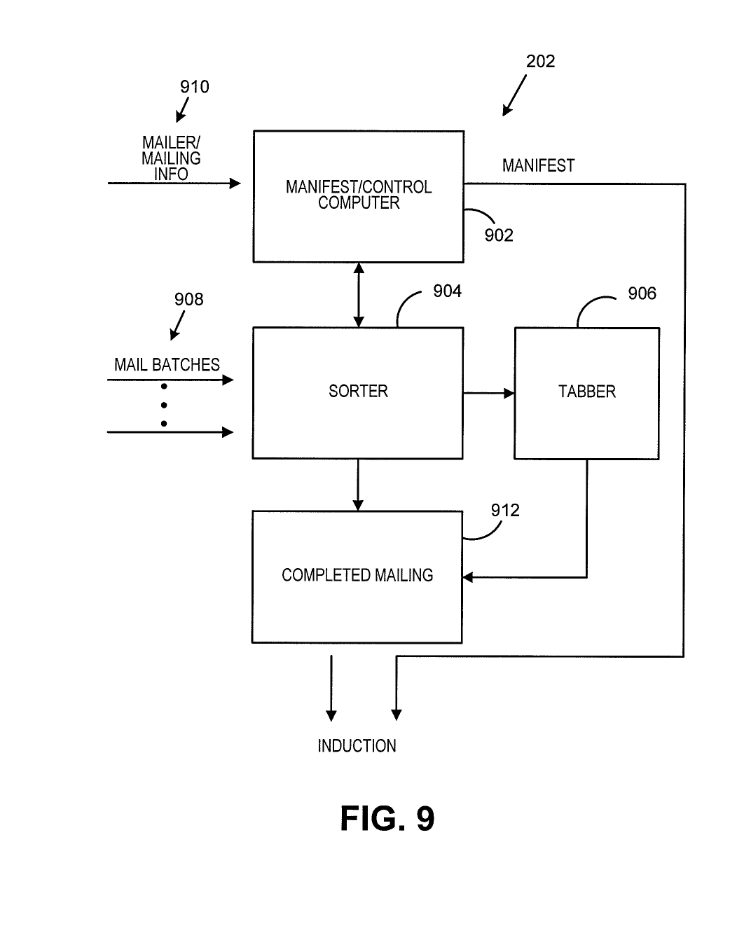

FIG. 9 is a block diagram that illustrates a pre-sort house 202 (cf. FIG. 2) that operates in accordance with aspects of the invention. Major components of the pre-sort house 202 may include (a) a computer 902 which controls other components and which generates manifests to be submitted to the USPS with pre-sorted mailings, (b) automatic letter sorting equipment 904, and (c) tabbing equipment 906. The tabbing equipment receives from the sorter 904 groups of envelopes that are addressed to the same delivery point, and applies adhesive tabs to each group of envelopes to form a consolidated mailpiece from each group. The tabber 906 may be physically integrated with the sorter 904. Tabbing technology—that may readily be adapted to implement the tabber 906 (or other tabbing units referred to herein)—is exemplified by tabbers that are commercially available from Profold, Inc., of Sebastian, Fla.

As indicated at 908, batches of mailpieces are fed into the sorter 904. The batches of mailpieces may be delivered to the pre-sort house, or picked up by the pre-sort house, from mailers who generated the mailpieces. For the purposes of generating increased postage savings, batches of mail from two or more mailers are commingled and sorted together in the sorter 904. Typically the mailpieces each include a 5-, 9- or 11-digit ZIP code in the form of a POSTNET barcode. Absent such barcode, or if not including the 9- or 11-digit barcode, an intake module (not separately shown) of the sorter 904 may apply optical character recognition (OCR) to the destination address on each mailpiece and may print a 9- or 11-digit barcode on the mailpiece. Thereafter, the sorter may sort the mailpieces by reading the barcode. (Alternatively, the sortation may be based on OCR reading.) The sorter 904 may operate generally in accordance with conventional practices, and may be constructed in a substantially conventional manner, except that the sorter 904 may be operated to sort the commingled batches of mailpieces to a further level of sortation than 3- or 5-digit ZIP code. Depending on the number of sort bins (not separately shown) in the sorter 904, it may only require two more sorting passes to sort down to the delivery point (9- or 11-digit ZIP code). Sortation to that level brings together mailpieces that are bound for a common delivery point. In other words, such sortation groups the mailpieces by delivery point.

In some embodiments, the sortation performed by the sorter 904 may be of a kind that is known as a “radix sort”, as referred to in commonly-assigned U.S. Pat. No. 7,258,277 and commonly-assigned U.S. Patent Publication No. 2006/0124512. As defined by the United States National Institute of Standards and Technology, a “radix sort” comprises a multiple pass distribution sort algorithm that distributes each item to a bucket according to part of the item's key beginning with the least significant part of the key. After each pass, items are collected from the buckets, keeping items in order, then redistributed according to the next most significant part of the key. The key may, in this case, be a delivery point ZIP code.

In some embodiments, sortation to delivery point may occur only when it is known (e.g., through prior reading of the ZIP code barcodes) that there is at least one duplicate mailpiece for a given delivery point.

As indicated at 910, in conjunction with receiving batches of mailpieces, data regarding each batch, including the number of pieces and the identity of the mailer, is fed into the manifest/control computer 902.

The completed, pre-sorted mailing indicated at 912 may be formed from 5-digit ZIP-sorted trays of mailpieces, into which are incorporated consolidated mailpieces formed by the tabber 906. The completed mailing is inducted into the USPS together with a manifest generated by the manifest/control computer 902.

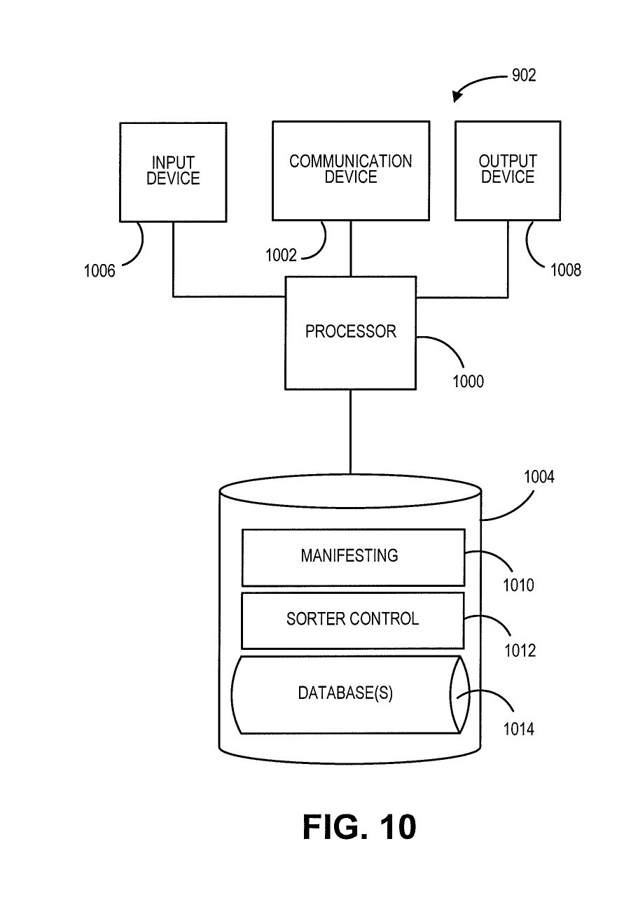

FIG. 10 is a block diagram of the manifest/control computer 902 shown in FIG. 9.

As depicted, the manifest/control computer 902 includes a computer processor 1000 operatively coupled to a communication device 1002, a storage device 1004, one or more input devices 1006 and one or more output devices 1008.

Communication device 1002 may be used to facilitate communication with, for example, other devices (such as the sorter 904 and/or computers, operated by mailers, from which manifests for incoming batches of mail may be received in electronic form). The input device(s) 1006 may comprise, for example, a keyboard, a keypad, a mouse or other pointing device, a microphone, knob or a switch, an infra-red (IR) port, a docking station, and/or a touch screen. The input device(s) 1006 may be used, for example, to enter information. Output device(s) 1008 may comprise, for example, a display (e.g., a display screen), a speaker, and/or a printer. The output device(s) 1008 may include, for example, a peripheral device for burning CD ROMs to record manifests for outbound pre-sorted mailings.

Continuing to refer to FIG. 10, storage device 1004 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. At least some of these devices may be considered computer-readable storage media, or may include such media.

In some embodiments, the hardware aspects of the manifest/control computer 902 may be entirely conventional.

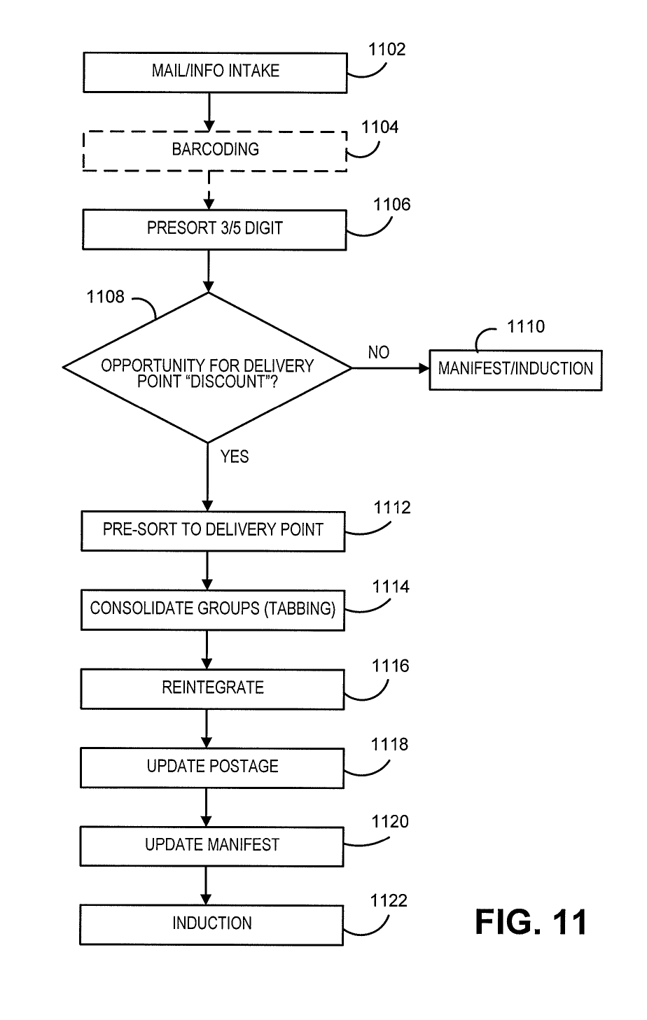

Storage device 1004 stores one or more programs or portions of programs (at least some of which being indicated by blocks 1010 and 1012) for controlling processor 1000. Processor 1000 performs instructions of the programs, and thereby operates in accordance with the present invention. In some embodiments, the programs may include a program or program module 1010 that programs the manifest/control computer 902 to prepare a manifest to accompany pre-sorted mailings generated by the pre-sort house 202 for induction into the USPS. The storage device 1004 may also store a program 1012 for controlling the sorter 904. Aspects of the programs 1010 and 1012 are described below in conjunction with FIG. 11.

There may also be stored in the storage device 1004 other software, such as one or more conventional operating systems, device drivers, communications software, database management software, etc.

Still further, the storage device 1004 may store various databases 1014 that are employed in connection with operation of the pre-sort house 202.

FIG. 11 is a flow chart that illustrates operation of the pre-sort house 202 and/or the manifest/control computer 902.

At 1102, the pre-sort house 202 takes in batches of mail for pre-sorting and data regarding the batches of mail. As indicated above, the data regarding the batches of mail may be input into the manifest/control computer 902. Indicated in phantom at 1104 is a step in which, if necessary, the sorter 904 or related equipment prints 9- or 11-digit barcodes on some or all of the mailpieces received at 1102. This may be done based on MLOCR (multi-line optical character recognition) reading of the addresses on the mailpieces.

At 1106, the sorter 904 is operated to sort the commingled batches of mail to the level of 3-digit or 5-digit ZIP codes. While this sortation is taking place, the sorter reads the barcodes from the mailpieces in the commingled batches of mail and communicates the indicated 9- or 11-digit ZIP codes to the manifest/control computer 902. The manifest/control computer, in turn, detects when a given 9- or 11-digit ZIP code has turned up more than once. When this occurs (i.e., when there is duplication of a given 11-digit ZIP code), it is an indication that more than one mailpiece in the commingled mail is addressed for delivery to the same delivery point, so that there are opportunities for saving postage by generating consolidated mailpieces from the commonly-addressed mailpieces. Alternatively or in addition to reading barcodes, the sorter 904 may employ optical character recognition (OCR).

A decision block 1108 follows block 1106. Decision block 1108 may, for example, be performed with respect to each 3-digit ZIP code or 5-digit ZIP code tray(s) of mailpieces. It is determined at decision block 1108 whether the tray(s) of mail contains duplicate 11-digit ZIP codes, and hence an opportunity for consolidation to the delivery point. If not, the tray of mail may be set aside for manifesting and induction without further processing, as indicated at 1110.

However, if a positive determination is made at 1108 (i.e., if it is determined that an opportunity for consolidation of mailpieces exists for the tray(s) of mail), then block 1112 follows decision block. At block 1112, the sorter 904 is operated further with respect to the tray(s) of mail in question to sort the mailpieces down to the 11-digit level (i.e., to delivery point).

(In some embodiments, the further sorting at 1112 is only performed if the opportunities for consolidation of mailpieces, and the resulting savings in postage, exceed a certain threshold that indicates that the savings would justify the further effort.)

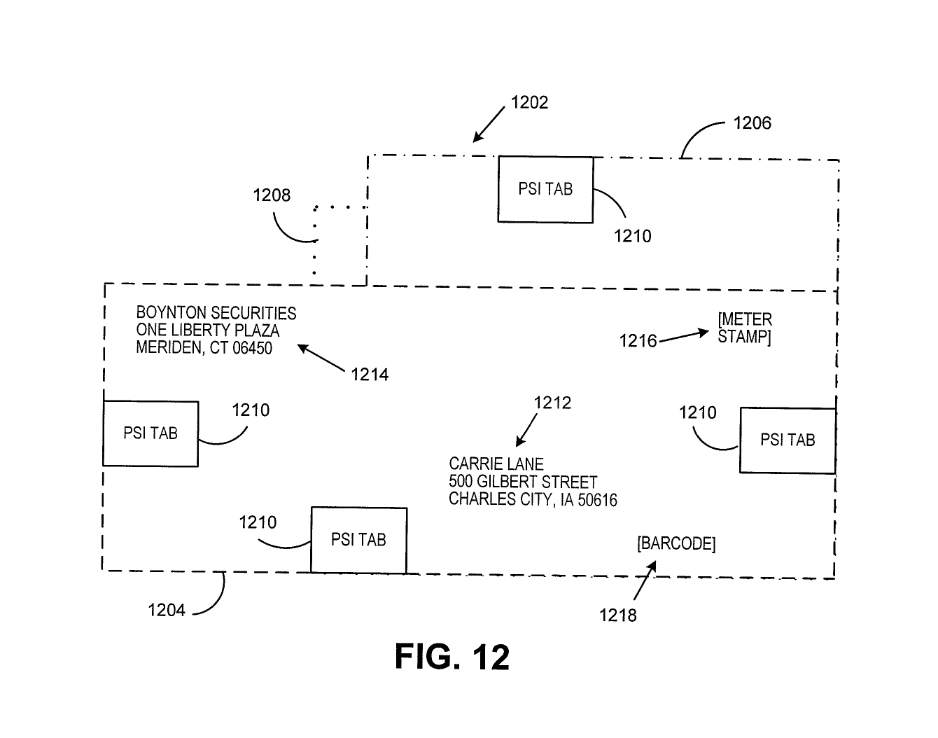

The sorting at 1112 results in groups of mailpieces that share a common destination delivery point. Block 1114 follows 1112. At 1114, each of the resulting groups of mailpieces is consolidated and tabbed together by the tabber 906 to produce a consolidated mailpiece from the group of commonly addressed mailpieces. FIG. 12 is a schematic plan view that illustrates one such consolidated mailpiece 1202.

For the example consolidated mailpiece 1202 shown in FIG. 12, it is assumed that three separate commonly addressed mailpieces were consolidated to form the consolidated mailpiece 1202. These three constituent mailpieces are respectively indicated by reference numeral 1204 (dashed line), reference numeral 1206 (dot dash line) and reference numeral 1208 (dotted line). Also seen in FIG. 12 are adhesive tabs 1210 applied to the constituent mailpieces 1204, 1206, 1208 by the tabber 906 (FIG. 6) to secure the constituent mailpieces together to form the consolidated mailpiece 1202. It will be noted that the top constituent mailpiece 1204 has a destination address 1212 that was printed thereon by the mailer of the constituent mailpiece 1204. The destination address 1212 is assumed to reflect the same destination address, though not necessarily the same addressee, that the top constituent mailpiece 1204 shares with the other constituent mailpieces 1206 and 1208. The top constituent mailpiece 1204 also has the mailer's return address 1214 printed thereon and a postage meter stamp 1216 (schematically indicated) that evidences payment of postage for the constituent mailpiece 1204. In addition, the POSTNET barcode printed on the constituent mailpiece 1204 is schematically indicated at 1218.

Although not shown in FIG. 12, it will be appreciated that the other two constituent mailpieces 1206 and 1208 also have the same destination address and POSTNET barcode printed thereon, and may have the same addressee or a different addressee/recipient who has the same mailing address as the addressee shown on mailpiece 1204. A postage meter stamp, adhesive postage stamp or permit mailing imprint (none of which are shown) may also be present on each of the other mailpieces 1206, 1208. Each of those mailpieces may also carry the return address for the respective mailer of each mailpiece.

In some embodiments, commonly addressed mailpieces may only be consolidated by being tabbed together if the same are compatible in size with each other. For example, in some embodiments, only envelopes that are of the same size are tabbed together.

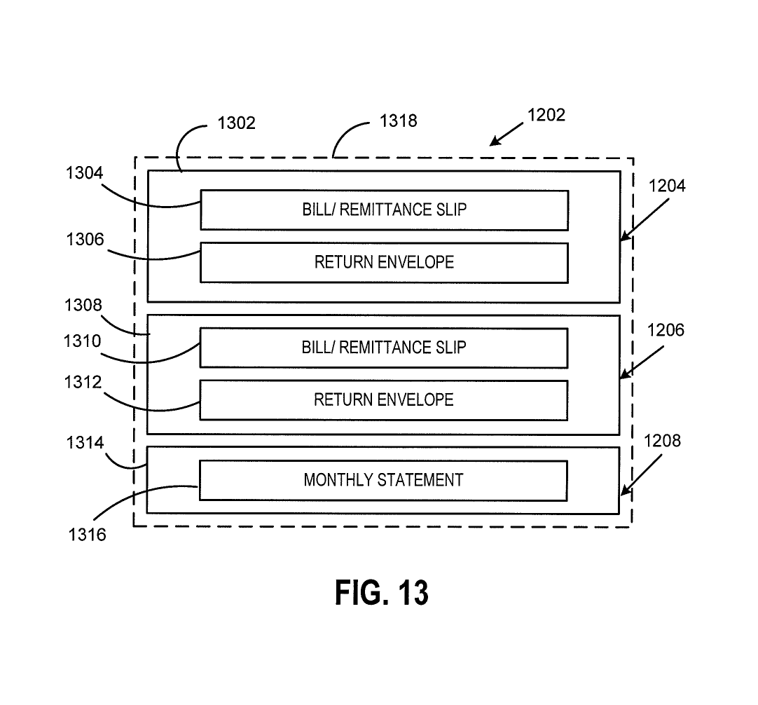

FIG. 13 is another schematic view of the example consolidated mailpiece 1202, showing contents of the constituent mailpieces. The constituent mailpieces are again indicated by reference numerals 1204, 1206, 1208. Constituent mailpiece 1204 is shown as including an outer envelope 1302 that contains a bill/remittance slip 1304 and a return envelope 1306. The bill/remittance slip 1304 was printed by the mailer of the constituent mailpiece 1204.

Constituent mailpiece 1206 is shown as including an outer envelope 1308 that contains a bill/remittance slip 1310 and a return envelope 1312. The bill/remittance slip 1310 was printed by the mailer of the constituent mailpiece 1206.

Constituent mailpiece 1208 is shown as including an outer envelope 1314 that contains a monthly statement 1316. The monthly statement 1316 was printed by the mailer of constituent mailpiece 1208.

The bill/remittance slip 1304, the bill/remittance slip 1310 and the monthly statement 1316 may each include a respective account number, with all of the account numbers being different from each other. It may be the case that at least two of the constituent mailpieces are addressed to different recipients.

The tabbing together of the constituent mailpieces is schematically indicated in FIG. 13 by dashed-line box 1318.

Referring again to FIG. 11, block 1116 follows block 1114. At block 1116, the consolidated mailpieces formed at 1114 are reintegrated into the particular 3- or 5-digit ZIP code tray from which their constituent mailpieces came. Then, at 1118, the manifest/control computer 902 recalculates the postage due for each of the consolidated mailpieces as compared to the postage that would have been due for the constituent mailpieces if the same were to be mailed separately. At 1120 the manifest/control computer 902 updates the manifest for the mailing to reflect the merger of the constituent mailpieces into the consolidated mailpiece. The manifest/control computer 902 performs this function for every consolidated mailpiece.

(In the above discussion, where a tray of mail all for one 3- or 5-digit ZIP code is referred to, it should also be understood that the reference may be to two or more trays of mail all for the same 3- or 5-digit ZIP code.)

At 1122, the pre-sort house 202 inducts the commingled, pre-sorted mailing (which includes consolidated mailpieces), accompanied by the updated manifest, into the USPS. The manifest may reflect postage savings derived both from pre-sorting by 3- or 5-digit ZIP code and from consolidation of mailpieces. In some embodiments, the USPS may refund the postage savings to the pre-sort house 202, which in turn shares the savings with the mailers who contributed to the commingled, pre-sorted mailing. In other embodiments, the mailpieces do not carry postage, or carry postage only at a minimum rate, prior to induction, and at induction the pre-sort house 202 pays to the USPS any postage due, or any additional postage due, but in an amount that reflects postage savings from pre-sorting and mailpiece consolidation. The pre-sort house may bill back the postage or additional postage to the mailers, plus a fee that represents a portion of the savings realized by the pre-sort house's activities.

The following examples illustrate the extent of postage savings that may be realized by consolidation of mailpieces. While these examples are presented primarily in the context of mailpiece consolidation at a pre-sort house, the savings are also fairly representative of what can be achieved by consolidation of mail messages at a service bureau (such as that illustrated in FIG. 1).

Assume first then that two constituent, commonly addressed mailpieces each weigh slightly less than one-half ounce apiece and that both would qualify for the 5-digit pre-sort discount if mailed separately. Further assume that the two constituent mailpieces are consolidated by tabbing into a consolidated mailpiece that also qualifies for the 5-digit pre-sort discount and that weighs no more than one ounce. At the time of writing, the two constituent mailpieces, if mailed separately, would each cost 31.2 cents in postage. However, the consolidated mailpiece formed from the two constituent mailpieces can also be mailed at a cost of 31.2 cents, yielding an effective discount in this case of 50% for the cost of postage for the two mailpieces.

Similarly, if three constituent mailpieces are consolidated, and are somewhat lighter in weight so that the resulting consolidated mailpiece still does not exceed one ounce, then the cost of postage remains 31.2 cents for the consolidated mailpiece, as compared to a postage cost of 93.6 cents (3 times 31.2) if the constituent mailpieces were mailed separately. In this case mailpiece consolidation provides almost a 67% effective discount.

To again change the example, assume now that the three constituent mailpieces each weigh one-half ounce. As a consequence, the resulting consolidated mailpiece would fall into the two-ounce, 5-digit pre-sort rate category, for which the postage would be 43.7 cents. This still represents an effective discount obtained by consolidation of over 53%.

It will be noted that this still very substantial effective discount reflects the characteristic of USPS rate schedules that the charge for the second ounce (and other additional ounces) is much less than the charge for the first ounce. In the case of 5-digit pre-sorted first class letters, the second ounce costs only 12.5 cents, as compared to 31.2 cents for the first ounce.

In a further example that highlights this point, assume that the consolidated mailpiece is formed of two constituent mailpieces weighing just less than an ounce apiece, so that the consolidated mailpiece falls in the two-ounce category. As in the previous example, the postage cost for the consolidated mailpiece is 43.7 cents, as compared to a postage cost of 62.4 cents (2 times 31.2) which would have been incurred had the two constituent mailpieces been mailed as separate items. In this example, then, an effective discount of almost 30% is achieved by mailpiece consolidation.

All of these examples of savings-by-mailpiece-consolidation are over and above the approximately 25% discount (as compared to the current 41 cent un-pre-sorted first class rate) afforded by 5-digit pre-sort operations alone. It will be noted that the combined pre-sort and consolidation effective discount may be on the order of two to three times (or more) greater than the pre-sort discounts alone. It is also notable that the postage savings proposed to be obtained herein by mailpiece (or, more broadly, mail message) consolidation (via, e.g., either pre-sort house or mail consolidation service bureau) do not require that the USPS make any changes to its current rate structure.

In some embodiments, the pre-sort house 202 may be one of a network of pre-sort houses located in various regions of the country. To increase the opportunities for consolidating mailpieces, the network of pre-sort houses may engage in bulk transfers of mail from region to region so that the mailpieces bound for a given region are concentrated at the pre-sort house located in the region. This practice may result both in increased postage savings and in enhanced “work sharing” on the part of the network of pre-sort houses. (It should be noted that a similar regionalization may be undertaken with respect to mail consolidation service bureaus. Within a network of service bureaus, mail messages may be transmitted in electronic form to the closest service bureau to the intended deliver point. The regionalization of messages in electronic form may provide environmental benefits in regard to reducing the distance that mail messages in printed form need to be transported.) In some embodiments, mailers may receive carbon credits for participating in a mail consolidation service bureau.

FIG. 12, by way of example, shows a consolidated mailpiece formed by tabbing together several originally independent constituent mailpieces. Tabbing technology for closing folded one-sheet mailpieces is well-known and can be readily adapted to application as described in connection with FIGS. 9, 11 and 12. As will be understood from previous discussion, however, the present invention also contemplates that constituent mailpieces may be physically secured to each other by one or more paper or plastic bands in lieu of or in addition to tabs. As still another alternative, the constituent mailpieces could be formed into a consolidated mailpiece by inserting them into another, larger (“outermost”) envelope, which may be sealed or otherwise closed to secure the constituent mailpieces together. In some embodiments the outermost envelope may be at least partially transparent to allow the destination address from one of the constituent mailpieces to be read through the outermost envelope so that the address from the constituent mailpiece serves as the destination mailpiece for the consolidated mailpiece. In other embodiments, the destination address may be printed on the outermost envelope. This may be done, for example, based on destination address information that is machine-read from at least one of the constituent mailpieces, possibly before the same are (is) inserted into the outermost envelope. In at least some cases, the destination address information machine-read from the constituent mailpieces to inform the printing on the outermost envelope may consist partially or entirely of a delivery-point-specific barcode such as an 11-digit ZIP code barcode.

In some embodiments, the pre-sort house 202 may include two or more different types of modules for consolidating common-destination constituent mailpieces into consolidated mailpieces. For example, the pre-sort house may include both a tabber and an inserter (not shown). The pre-sort house may operate (under the control of manifest/control computer 902) such that a group of common-destination constituent mailpieces that are compatible in size is routed to the tabber, whereas if the group of common-destination mailpieces are not compatible in size, then the same are routed to the inserter for insertion of the constituent mailpieces into an outermost envelope. The sizes of the constituent envelopes may be automatically detected by a suitable size-detection module (not shown), or alternatively may be known from information input to the manifest/control computer 902 concerning at least some of the mailings to be commingled.

In some embodiments, the pre-sort house may also include a printer (not shown), under the control of the manifest/control computer 902. The printer may be controlled to print information on the top constituent mailpiece of consolidated mailpieces to indicate the originating mailer(s) for middle or bottom constituent mailpieces in the consolidated mailpieces. In addition or alternatively, such information may be printed on the adhesive tabs (if present), the bands (if present) for forming the consolidated mailpieces, or the outermost envelope (if present).

The manifest/control computer 902 may include accounting capabilities to track amounts due between the pre-sort house and the mailers. In some embodiments, the savings by 3- or 5-digit ZIP pre-sorting and from mailpiece consolidation may be calculated essentially to the penny and may be divided between the pre-sort house and the participating mailers according to pre-agreed formulas. In other cases, the manifest/control computer 902 may determine a statistical profile of each mailing and use an appropriate formula to calculate amounts due between the pre-sort house and the mailers in a manner that generally reflects expected savings to be achieved by the operations of the pre-sort house and an agreed-upon division of the expected savings. In other possible arrangements, the pre-sort house's experience with some or all mailers may allow it to extend an effective flat-rate discount per piece to each participating mailer.

In some embodiments, the pre-sort house may find it advisable not to consolidate mailpieces from mailers that are independent of each other unless some or all of the mailers have consented to such a practice. In some embodiments, the amount of discount remitted to a mailer on account of consolidation of its mailpieces with others may be varied depending on whether the mailer has agreed to accept its mailpieces being top, middle or bottom constituent mailpieces in consolidated mailpieces. Accordingly, the manifest/control computer 902 may control the sorter 904 such that the order of constituent mailpieces in a consolidated mailpieces is not random, but rather reflects pre-agreed ordering of mailpieces in compliance with agreements worked out in advance with the mailers who contributed to the commingled mailing created by the pre-sort house 202. As is implied by previous statements herein, mailers may bid for preferred positioning of their mailpieces in consolidated mailpieces formed therefrom.

The pre-sort house may share with the mailers the postage savings realized by consolidating mailpieces as described herein. This may provide the mailers with incentives for turning their mail over to the pre-sort house.

It is also contemplated that the pre-sort house may implement recipient preferences as to the order in which constituent envelopes appear in consolidated mail pieces.

In some embodiments, the pre-sort house may have capabilities for reading the mail recipients' names from the prospective constituent mailpieces. The pre-sort house may operate such that mailpieces having a common destination delivery point are tabbed together only if addressed to the same mail recipient.

As is the case with the mail consolidation service bureau, the pre-sort house may coordinate operations of participating mailers or otherwise encourage mailers to deliver overlapping mailings at about the same time to maximize the opportunities for mailpiece consolidation by delivery point sorting.

In some embodiments, the manifest/control computer 902 may store a database (not separately shown) of electronic mail addresses for the mail recipients. Further, the manifest/control computer 902 may generate an index for each consolidated mailpiece that it constructs, where the index lists the constituent mailpieces of the consolidated mailpieces by the name of the mailer. The manifest/control computer 902 may send the index as an electronic mail message to the recipient in question. The index may be similar to the e-mail index discussed above in connection with the mail consolidation service bureau.

Up to this point, there have been descriptions of three manners of consolidating mail messages into consolidated mailpieces. The first two, both of which may occur at a mail consolidation service bureau, are (1) (A) entirely electronic consolidation, followed by printing of the consolidated mail messages and insertion of same into a single envelope, and (1) (B) sorting and sequencing of mail messages in electronic form having a common destination, printing and inserting the common-destination mail messages into more than one envelope, and securing together of the envelopes to form the consolidated mailpiece. (It should be noted that (1) (A) and (1) (B) may overlap, in that in (1) (B) at least some of the constituent envelopes of the consolidated mailpiece may themselves contain more than one mail message.) In the third manner of consolidation, completed mailings from independent mailers are physically commingled at a pre-sort house or similar facility and pre-sorted to delivery point to produce consolidated mailpieces from originally independent mailpieces.

Other variations are possible, however. For example, a single mailer that mails, e.g., to more than one recipient at a given address may employ either technique (1) (A) or technique (1) (B). In either a service bureau or with a single mailer, a variation on (1) (B) may not include sorting of mail messages in electronic form, but may sort mailpieces at the end of the printing/inserting process to bring common-destination mailpieces together for consolidation by tabbing or the like.

For the most part, the above discussion has assumed that the mailings from the mail consolidation service bureau 106 or from the pre-sort house 202 are appointed for induction into the U.S. Postal Service. However, the invention is in general equally applicable for use in other countries besides the United States, in which case the mailings may be inducted into the postal authority for the respective country. Further, the invention is also suitable for use in a scheme in which a letter and/or parcel carrying organization (e.g., a private carrier) other than the postal authority is to perform at least part of the handling and delivery of the mailpieces. For example, if a large number of mail messages are to be consolidated, such that the resulting consolidated mailpiece is too large for an envelope, the printed mail messages may be inserted into a box or a similar container and may be dispatched for delivery via FedEx or UPS, or via parcel post.

In cases where consolidated mailpieces include transparent plastic outermost envelopes or are banded together by transparent plastic bands, it may be preferable that the plastic in question have a matte finish to facilitate machine and/or human reading of address information through the plastic.

The method steps described herein need not be performed in the order set forth above. Rather, the steps may be performed in any order that is practicable.

With respect to the mail consolidation service bureau 106, it has primarily been proposed herein that the participating mailers send the mail messages to the service bureau in electronic form. Alternatively, however, the mail consolidation service bureau may receive at least some of the mail messages from the mailers in the form of one or more printed paper sheets. The mail consolidation service bureau may sort the paper mail messages and insert those having a common destination address into a common envelope to form a consolidated mailpiece, or may insert the mail messages into separate envelopes to be sorted together and secured to each other to form a consolidated mailpiece. In some embodiments, if the mail consolidation bureau produces plural mailpieces to the same destination—which are to be subject to consolidation—the constituent mailpieces may be produced in sequence in a group of mailpieces that are to be outsorted together for physical consolidation.

At least some aspects of the invention may provide environmental benefits. For example, consolidated printing of mail messages at the mail consolidation service bureaus may save paper and also may lead to reduced expenditures of energy by reducing the total weight of printed mail messages to be transported to the recipients.

The computers described herein may perform other functions in addition to those explicitly mentioned. For example, one or more of the computers may perform list processing.

Throughout this disclosure, wherever reference is made to tabbing constituent mailpieces together to form a consolidated mailpiece, it should also be understood that the constituent mailpieces may alternatively be banded together, or inserted together into a common envelope.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
receiving a plurality of mail messages from different mailers;
sorting together ones of the mail messages that are all appointed for delivery by mail to the same mail recipient, at least two of said mail messages including a respective account number for the mail recipient; and
combining the mail messages that have been sorted together into a single combined mailpiece addressed to said mail recipient;
wherein all of the account numbers included in the mail messages are mutually different from each other.

2. The method of claim 1, wherein all of the mail messages are received in electronic form.

3. The method of claim 2, wherein each of the mail messages is received in association with a recipient identification code (RID) that corresponds to the mail recipient, said RID different from each of said account numbers.

4. The method of claim 2, wherein the single combined mailpiece is for notifying the mail recipient of at least two account statements for which the mail recipient owes payment.

5. The method of claim 1, wherein the combining step includes tabbing together a plurality of envelopes.

6. The method of claim 1, wherein the plurality of mail messages include a first mail message that includes a first account statement issued by a first payment card account issuer and a second mail message that includes a second account statement issued by a second payment card account issuer, the second payment card account issuer different from the first payment card account issuer.

7. The method of claim 6, wherein the first and second mail messages are received in electronic form.

8. The method of claim 1, wherein the single combined mailpiece includes a return envelope for allowing the mail recipient to remit at least one payment.

9. The method of claim 1, further comprising:
generating an index for the single combined mailpiece and sending the index to the mail recipient.

10. A consolidated mailpiece comprising:
at least one outer envelope;
a first return envelope contained in the at least one outer envelope;
a first remittance slip, appointed for insertion into the first return envelope, the first remittance slip addressed to a first mailer for return to the first mailer and including a first account number, the first remittance slip contained in the at least one outer envelope;
a second return envelope contained in the at least one outer envelope; and
a second remittance slip, appointed for insertion into the second return envelope, the second remittance slip addressed to a second mailer for return to the second mailer and including a second account number, the second remittance slip contained in the at least one outer envelope, the second mailer different from the first mailer, the second account number different from the first account number.

11. The consolidated mailpiece of claim 10, wherein the at least one outer envelope includes:
a first outer envelope that contains the first return envelope and the first remittance slip; and
a second outer envelope that contains the second return envelope and the second remittance slip, the second outer envelope secured to the first outer envelope.

12. The consolidated mailpiece of claim 11, wherein the second outer envelope is secured to the first outer envelope by adhesive tabs.

13. The consolidated mailpiece of claim 11, wherein the second outer envelope is secured to the first outer envelope by a paper or plastic band.

14. The consolidated mailpiece of claim 11, further comprising:
an outermost envelope;
and wherein the second outer envelope is secured to the first outer envelope by both the first outer envelope and the second outer envelope being contained within the outermost envelope.

15. The consolidated mailpiece of claim 14, further comprising:
a printed index, contained in the at least one outer envelope, the printed index listing mail messages printed on sheets contained in the at least one outer envelope.

16. The consolidated mailpiece of claim 10, wherein a mail message is contained in the outer envelope.

17. A method comprising:
receiving a plurality of mail messages, each of said mail messages originating from a respective one of a plurality of entities, at least two of said mail messages originating from different entities, all of said mail messages appointed for delivery to the same mail recipient, said plurality of entities including at least two of the following types of entities: (a) a payment card issuer; (b) an energy utility; (c) a telecommunications carrier; (d) a mortgage servicing entity; (e) a taxing authority; (f) a securities brokerage company; (g) an insurance company; and (h) a government agency; and
combining the received mail messages into a single combined mailpiece addressed to said mail recipient.

18. The method of claim 17, wherein each of the mail messages includes a monthly account statement issued for said mail recipient by said respective one of said plurality of entities.

19. The method of claim 18, wherein said mail messages are received in electronic form.
